(19) United States
(12) Patent Application Publication
(10) Pub. No.: US 2026/0122545 A1
(43) Pub. Date: Apr. 30, 2026

(54) MULTIPLE SIMULTANEOUSLY ACTIVE GATEWAYS IN A PERSONAL IOT NETWORK

(71) Applicant: CONVIDA WIRELESS, LLC, Wilmington, DE (US)

(72) Inventors: Dale SEED, Allentown, PA (US); Quang LY, North Wales, PA (US); Catalina MLADIN, Hatboro, PA (US); Lu LIU, Conshohocken, PA (US)

(21) Appl. No.: 19/116,715

(22) PCT Filed: Oct. 2, 2023
(86) PCT No.: PCT/US2023/075701

§ 371 Date: Mar. 28, 2025

Related U.S. Application Data
(60) Provisional application No. 63/378,208, filed on Oct. 3, 2022.

(51) Int. Cl. H04W 36/12; H04W 4/70; H04W 48/18; H04W 88/16

(52) U.S. Cl. CPC H04W 36/12; H04W 4/70; H04W 48/18; H04W 88/16

(57) ABSTRACT

Methods and procedures are described herein to support the management of multiple simultaneously active gateways within a PIN. A method may comprise receiving, by a PEMC, two PIN join requests from two PIN elements, comprising PIN client profile information indicating that the respective PIN element can serve as a gateway, determining, based on each PIN client profile information, to configure the PIN elements as gateways, receiving, from a third PIN element, a PIN join request comprising PIN client profile information, determining, based on PIN client profile information of each PIN element, to assign the first PIN element as a default gateway and the second PIN element as a backup gateway for the third PIN element, and sending, to the PIN elements, a notification indicating the first PIN element is serving as the default gateway and the second PIN element is serving as the backup gateway for the third PIN element.

### CROSS-REFERENCED TO RELATED APPLICATIONS

This application claims the benefit of, and incorporates herein by reference, U.S. Provisional Application No. 63/378,208, titled “Methods and Procedures to Support Multiple Simultaneously Active Gateways within a Personal IoT Network,” filed Oct. 3, 2022.

### BACKGROUND

Internet of Things (IoT) devices are becoming ubiquitous as more companies release new products in different market segments and consumers adopt the technology in their home and for personal use. Devices such as those in smart homes, e.g., large and small appliances, lighting and switches, security cameras, motion and water detectors, meter readers, door locks and garage door openers, as well as personal wearables such as AV/VR glasses, headsets and headphones, medical and health sensors, are beginning to be widely adopted by consumers for their utility and convenience. 3GPP has recognized the burgeoning market opportunities and have initiated various works within the standards organization to support the creation of Personal IoT Networks (PIN) that connect IoT devices together for communications within the PIN and outside of the PIN.

One such work is found in the 3GPP SA6 working group in which application enabler layers are defined to specify application layer APIs to assist companies to incorporate 3GPP technologies quickly and easily into their products. An SA6 study has started to define application enabler functionalities for supporting personal IoT network applications called PINAPP. The results of this study are actively being captured in 3GPP TR 23.700-78.

Within a PIN, a single PIN Element with Gateway Capability (PEGC) may become overloaded or may become unresponsive. For this reason, support for multiple simultaneously active PEGCs within the same PIN can be advantageous. Multiple simultaneously active PEGCs in the same PIN allows for load balancing PIN communications across the PEGCs. This load balancing can minimize network congestion within the PIN and can reduce PIN message delivery latency. It also provides redundancy in case a PEGC becomes overloaded and/or goes unresponsive. When multiple simultaneously active PEGCs are available in the same PIN, PIN elements can transition to using another PEGC to relay their messages if/when a PEGC becomes overloaded and/or goes unresponsive. This transition can take place seamlessly without having to involve a PIN Element with Management Capability (PEMC) to detect a PEGC issue, assign the role of PEGC to another PIN element, or notify other PIN elements of the new PEGC. This can streamline transitioning of PIN elements over to using different PEGCs if/when needed, which can save time and overhead.

### SUMMARY

Disclosed herein are methods to support the management of multiple simultaneously active PEGCs within a PIN. In the proposed methods, a PEMC may receive a PIN join request from a first PIN element comprising PIN client profile information of the first PIN element. The PIN client profile information of the first PIN element may indicate that the first PIN element is capable of serving as a gateway, or PEGC, in the PIN. The PEMC may also receive a second PIN join request from a second PIN element comprising PIN client profile information of the second PIN element. The PIN client profile information of the second PIN element may also indicate that the second PIN element is capable of serving as a gateway, or PEGC, in the PIN. The PEMC may determine that the first and/or the second PIN elements are capable of serving as a gateway, or PEGC, of the PIN based on the PIN client profile information of the respective PIN elements. The PEMC may configure the first and/or the second PIN elements as gateways, of PEGCs, of the PIN based on the PIN client profile information of the respective PIN elements. The PEMC may receiving a third PIN join request from a third PIN element comprising third PIN client profile information. The PEMC may determine that the third PIN element is in need of one or more gateways, or PEGCs. The PEMC may assign the first PIN element as a default gateway for the third PIN element and the second PIN element as a backup gateway for the third PIN element based on the PIN client profile information of first, second, and third PIN elements. The PEMC may send a notification to the first PIN element comprising information that indicates that the first PIN element is serving as the default gateway for the third PIN element. The PEMC may send a notification to the second OIN element comprising information indicating that the second PIN element is serving as the backup gateway for the third PIN element. The PEMC may send a response the third PIN element. The response may indicate that the first PIN element is serving as the default gateway and the second PIN element is serving as the backup gateway for communicating messages between the third PIN element and other elements in the PIN. The PEMC may detect the expiration of a heartbeat timer for the first PIN element. The expiration of the heartbeat timer may indicate that the first PIN element is no longer capable of serving as a gateway, or PEGC, for the third PIN element. Based on the expiration of the heartbeat timer, the PEMC may configure the second PIN element as the default gateway for third PIN element.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows an example PINAPP architecture;

FIG. 2 shows an example process in which a PIN element is assigned the role of a PEGC in a reactive manner when other PIN elements join the PIN;

FIG. 3 shows an example process in which a PEMC establishes a PIN and proactively assigns multiple PIN elements the role of PEGC when the PIN is established;

FIG. 4 shows an example process in which a PEGC notifies a PEMC it is no longer able to continue the role of PEGC;

FIG. 5 shows an example in which a PIM element is not able to communicate with a default PEGC and switches over to using a backup PEGC;

FIG. 6 shows an example process in which a PEGC notifies another PEGC that is has an impending failure;

FIG. 7 shows an example process in which a PIN encounters failures when attempting to communicate with both a default and a backup PEGC;

FIG. 8 shows an example process in which a PIN element encounters a failure with a PEGC and then takes on the PEGC role in response;

FIG. 9 shows another example process in which a PIN element communicates with a PIN element outside the PIN via a backup PEGC;

FIG. 10 shows an example process for PEGC location-based operations;

FIG. 11 shows an example process for PEGC schedule-based operations;

FIG. 12 shows an example GUI for PIN administration;

FIG. 13 shows an example GUI for client PIN configuration.

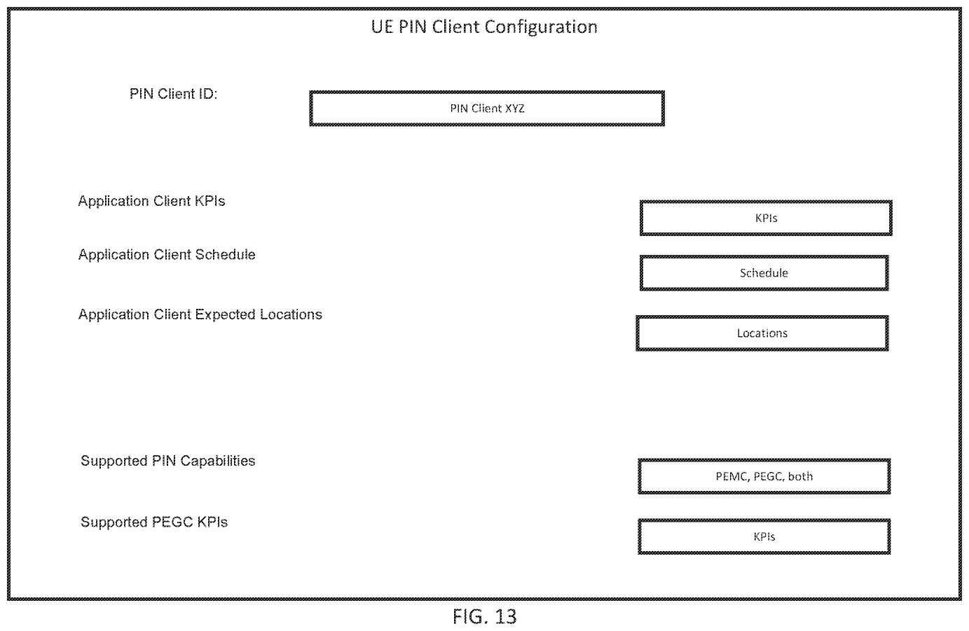

FIG. 14A shows an example communications system in which the methods and apparatuses described and claimed herein may be an aspect of;

FIG. 14B shows a block diagram of an example apparatus or device configured for wireless communications;

FIG. 14C shows a system diagram of an example radio access network (RAN) and core network;

FIG. 14D shows a system diagram of another example RAN and core network;

FIG. 14E shows a system diagram of another example RAN and core network;

FIG. 14F shows a block diagram of an example computing system; and

FIG. 14G shows a block diagram of another example communications system.

### DETAILED DESCRIPTION

Methods are described herein to support the management of multiple simultaneously active PEGCs within a PIN. Comprised are several proposed PIN profile enhancements which define additional information elements that may be exchanged between a PIN Server, PEMC, PEGCs and PIN elements within a PIN to enable and help manage multiple simultaneously active PEGCs. Leveraging these new informational elements, several procedures are also proposed. These may comprise a procedure in which the PEMC may reactively load balance the PIN by assigning the role of a PEGC to a PIN element in response to a new PIN element joining the PIN. To complement this reactive procedure, a proactive procedure is also defined in which the PEMC establishes a PIN and when doing so proactively assigns multiple PIN members with the role of a PEGC with the expectation that there will be a large number of PIN elements joining the PIN. Procedures are also defined which enable PIN elements to react to conditions where PEGCs go unresponsive or become overloaded. In these cases, the procedures define how the PIN elements can transition to using backup PEGCs or trigger the assignment of new PEGCs in the PIN if/when existing PEGCs are not available or do not meet the requirements of the PIN elements. Procedures are also defined to support transitioning PIN elements to use different PEGCs based on either the location of the PIN elements and PEGCs or their operating schedules. As used herein, the terms “method” and “procedure” and synonymous and may be used interchangeably.

An example method may comprise a PIN with various PIN elements which may send PIN client profile information to a PEMC via a PIN join request which the PEMC uses to determine assignment of the PIN element to a default PEGC and one or more backup PEGCs that the PIN element is to use for communicating with other PIN elements. The client profile information may comprise one or more of the following: application client Key Performance Indicators (KPIs), application client schedules, a mobility indicator, current location, expected locations, access type, and/or a PIN group list.

Additionally, a PIN element may receive updated PIN client profile information from a PEMC which the PIN element uses to determine which PEGCs to communicate with, when to communicate with the PEGCs and where to communicate with the PEGCs, wherein the updated client profile information may comprise one or more of the following: identifiers, availability schedules and locations of a default PEGC and one or more backup PEGCs.

Also, a PIN element may receive an indication from the PEMC indicating the PIN element is permitted to transition to a role of PEGC if/when the default and/or backup PEGCs become unresponsive to the PIN element and transitioning the PIN element to the role of PEGC when detecting the default and/or backup PEGCs becomes unresponsive.

Furthermore, a PIN element may notify a PEMC if/when the default and/or backup PEGCs are unresponsive or no longer meeting the KPI requirements of the PIN element.

In the proposed methods, a PEMC may receive PIN client profile information from a PIN element which the PEMC uses to determine assignment of the PIN element to a default PEGC and one or more backup PEGCs, wherein the client profile information may comprise one or more the following: application client KPIs, application client schedules, a mobility indicator, current location, expected locations, access type, PIN group list.

Additionally, a PEMC may determine that an additional PEGC is needed in the PIN, wherein the determination may be made when a new PIN element joins the PIN, when the PEMC fails to receive a heartbeat from a PEGC, or when a notification is received from a PIN element or PEGC.

Also, a PEMC may compare information contained in PIN client profiles and dynamic PIN profile information stored and maintained by the PEMC to determine one or more candidate PIN elements to transition to the role of PEGC, wherein the information may comprise one or more of the following: an indicator that a PIN element supports the capability to serve as a PEGC, PEGC current and supported KPIs and schedules, PIN element application client required KPIs and schedules, current and expected locations of PEGCs and PIN elements, and PEGC supported schedules.

Furthermore, a PEMC may send a notification to a PIN element to inform it that it has been assigned the role of a PEGC, wherein the information may comprise one or more of the following: a list of PIN elements that the PEGC is to service as the default PEGC, a list of PIN elements that the PEGC is to service as the backup PEGC, updated schedule information indicating that the PEGC must be available for certain time windows to service PIN element communication requests, and routing authorization policies defining the list of PIN elements or PIN groups that PIN elements are permitted to communicate with via the use of the PEGC.

Additionally, a PEMC may send updated PIN client profile information to a PIN element which the PIN element uses to determine which PEGCs to communicate with, when to communicate with the PEGCs and where to communicate with the PEGCs, wherein the updated client profile information may comprise one or more of the following: identifiers, availability schedules and locations of a default PEGC and one or more backup PEGCs.

Also, a PEMC may send an indication to a PIN element indicating the PIN element is permitted to transition to role of PEGC if/when the default and/or backup PEGCs become unresponsive to the PIN element.

Furthermore, a PEMC may receive a notification from a PEGC or a PIN element if/when the default and/or backup PEGCs for the PIN element are unresponsive or no longer meeting the KPI requirements of the PIN element.

In the proposed methods, a PIN element capable of serving as a PEGC may send PIN client profile information to a PEMC within a PIN join request which the PEMC uses to determine assignment of the role of PEGC to the PIN element, wherein the client profile information may comprise one or more the following: supported PEGC schedule, supported PEGC KPIs, mobility indicator, current location, expected locations, access type, and/or battery level.

Additionally, a PIN element capable of serving as a PEGC may receive from the PEMC dynamic PIN profile information that may comprise one or more of the following: a list of PIN elements that the PEGC is to service as the default PEGC, a list of PIN elements that the PEGC is to service as the backup PEGC, updated schedule information for indicating when the PEGC must be available to service PIN element communication requests, and routing authorization policies defining the list of PIN elements or PIN groups that PIN elements serviced by the PEGC are permitted to communicate with.

Furthermore, a PIN element capable of serving as a PEGC may send a notification to the PEMC indicating that the PEGC is unable to continue in the role of a PEGC or that another PEGC in the PIN is either unresponsive or unable to meet the communication requirements (KPIs, schedule, etc.) of its assigned PIN elements.

The following abbreviations may be used herein:

| | |
|---|---|
| 3GPP | Third Generation Partnership Project |
| 5GS | 5G System |
| AC | Application Client |
| AF | Application Function |
| API | Application Programming Interface |
| AS | Application Server |
| FQDN | Fully Qualified Domain Name |
| GUI | Graphical User Interface |
| IoT | Internet of Things |
| MNO | Mobile Network Operator |
| PEGC | PIN Element with Gateway Capability |
| PEMC | PIN Element with Management Capability |
| PIN | Personal IoT Network |
| PINAPP | Personal IoT Network Application (enabler layer) |
| PINE | PIN Element |
| SIM | Subscriber Identity Modules |
| UE | User Equipment |
| VAL | Vertical Application Layer |

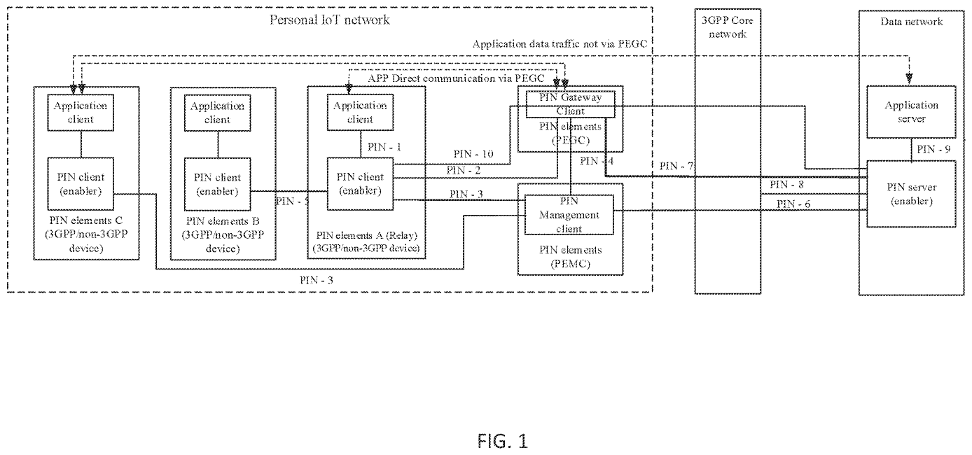

FIG. 1 shows an example PINAPP architecture defined thus far in 3GPP TR 23.700-78. The architecture defines the PINAPP application enabler layer for managing personal IoT networks. A PIN server may be deployed by a network operator in a data network to provision configuration information to PIN elements and may authorize the creation of PINs. PIN elements may be nodes in the PIN (e.g., endpoint devices, gateways, etc.). PIN Elements with Management Capabilities (PEMC) may be responsible for PIN management. PIN Elements with Gateway Capabilities (PEGC) may be responsible for traffic routing between PIN elements. Within a PIN element, there may be one PIN client and one or more Application clients.

A PIN element may be a 3GPP device that either has a SIM card with an associated 3GPP subscription or may not have a SIM card. PIN elements without a SIM card may be provisioned with a 3GPP defined user identifier in order to use the 5G network and its services. Alternatively, a PIN element may be a non-3GPP device that operates using different access technologies, such as Wi-Fi or Bluetooth.

PIN communications may occur over operator managed spectrum such as that used by Uu and PC5 interfaces or over non-operator managed spectrum such as Wi-Fi and Bluetooth. The Uu interface may be defined as the radio interface between a UE and a RAN node, or a base station, and the PC5 interface is defined as the radio interface for direct communication between two UEs. Both interfaces may use 3GPP defined access technologies.

Prior to the creation of a PIN, a PEMC may obtain authorization from a PIN server that is managed by an operator. The PEMC may be controlled by an authorized administrator or user, e.g. a homeowner or a family member of the homeowner who wants to create PINs in the home. Upon authorization, a PEMC may then create and delete PINs and add or remove member PIN elements to the PIN. The PEMC may also designate a PIN element to become a PEGC in order to provide data traffic routing functionality to the PIN. Routing in this case may be for intra-PIN, inter-PIN, and through the 5GS, or 5GS-PIN. Intra-PIN routing may be between members of a PIN, inter-PIN routing may be between members of two different PINs, and 5GS-PIN routing may be between a member of a local PIN to a remote PIN member (e.g. a UE) over the 5G network. The remote PIN member may be a member of the local PIN or may have been authorized by a PIN server to access the local PIN. In addition to using a PEGC to route intra-PIN traffic, a PIN element may also communicate directly with another PIN element within the PIN if it is authorized to do so. A PIN element that is a non-3GPP device and wants to join a PIN may be assigned a user identifier by the PEMC in order to communicate over the 5G network and to use the services of the 5G network.

### PIN Profile Enhancements

PIN profile information may comprise both static and dynamically changing information elements. The PIN profile information may be stored and maintained by the PIN server, PEMC and PEGC. Dynamically changing PIN information may also be exchanged between the PIN server, PEMC and PEGC based on events (e.g. PIN element joining or leaving, PIN element capability is changed). The type of PIN information as well as the initiator and recipient may vary depending upon the type of event that occurs, and the PIN elements involved.

To support multiple simultaneously active PEGCs within the same PIN, a PIN profile may comprise one or more new information elements. For example, in Table 1, a PIN profile may comprise one or more of the following new informational elements: Targeted PIN KPIs. In Table 2, the following new informational elements are proposed in the dynamic profile: Current PIN KPIs, >Supported PEGC KPIs, >Current PEGC KPIs, >PEGC Schedule, >>PIN Element or Group ID, >>PEGC Role, >>Routing Authorization, >PIN group List, >capabilities, >Device identifier, >Battery Level, >PINE Schedule, >Heartbeat time, >Current location, >Expected locations, >Access type, >Access code, >Default PEGC, >Backup PEGCs List, >Application List, >>Application Identity, >>Application KPIs, >Assume PEGC role, >Current PIN role, >Supported PEGC schedule, >Supported PEGC KPIs, PIN Groups List, >PIN group ID, >Max #Members, >Member PINEs, and >Group Endpoint. And, in Table 3 the following new informational elements are proposed in the PIN client profile: >Application schedule, >Application KPIs, Mobility, Current location, Expected locations, Access type, Battery level, PIN group list, Heartbeat timer, Default PEGC, Backup PEGCs list, Assume PEGC role, Current PIN role, Supported PEGC schedule, and Supported PEGC KPIs.

The use of the “>” symbol in the tables below indicates that an information element is a sub-element of another information element. The use of the “>>” symbol in the tables below indicates an information element is a sub-element of another sub-element.

TABLE 1
PIN Profile Enhancements

| Informational | | PIN | PEM | PEG | PIN |
|---|---|---|---|---|---|
| Element | Parameter Description | Server | C | C | E |
| PIN ID | The identifier of | Y | Y | Y | Y |
| | the PIN | | | | |
| PIN | Human-readable | Y | Y | Y | Y |
| Description | description of the PIN, | | | | |
| | for example, the | | | | |
| | company name, location | | | | |
| | or the type of service. | | | | |
| PEMC ID list | The list of identifiers | Y | Y | Y | Y |
| | of the PIN elements | | | | |
| | which can be allowed | | | | |
| | to take the role as | | | | |
| | PEMC (e.g.: PIN client | | | | |
| | ID, UE GPSI etc.,) | | | | |
| PEMC | Endpoint information | Y | N | Y | Y |
| Endpoint | (e.g. URI, FQDN, IP | | | | |
| | address) used to | | | | |
| | communicate with | | | | |
| | the PEMC. | | | | |
| PEGC ID list | The list of identifiers | Y | Y | Y | Y |
| | of the PIN elements | | | | |
| | which can be allowed | | | | |
| | to take the role as | | | | |
| | PEGC (e.g.: PIN client | | | | |
| | ID, UE GPSI etc.,) | | | | |
| PIN Server ID | The identifier of | N | Y | Y | Y |
| | the PIN server that | | | | |
| | serves the PIN | | | | |
| PIN server | Endpoint information | N | Y | Y | Y |
| Endpoint | (e.g. URI, FQDN, IP | | | | |
| | address) used to | | | | |
| | communicate with the | | | | |
| | PIN server. | | | | |
| PIN Elements | List of PIN elements | Y | Y | Y | N |
| List | which can be allowed | | | | |
| | to join the PIN | | | | |
| | > PIN element ID | | | | |
| Targeted PIN | Targeted KPIs for | Y | Y | Y | N |
| KPIs | this PIN (e.g., | | | | |
| | minimum PIN | | | | |
| | communication request | | | | |
| | service rate, maximum | | | | |
| | PIN communication | | | | |
| | response time, | | | | |
| | minimum number of | | | | |
| | supported PIN elements, | | | | |
| | minimum range/distance | | | | |
| | (e.g., feet) between | | | | |
| | PEGC and the PIN | | | | |
| | elements it services) | | | | |

TABLE 2
Dynamic PIN Profile Enhancements

| Informational | | PIN | | |
|---|---|---|---|---|
| Element | Parameter Description | Server | PEMC | PEGC |
| PIN ID | The identifier of the PIN | Y | Y | Y |
| PIN | Human-readable | Y | Y | Y |
| Description | description of | | | |
| | the PIN, for example, | | | |
| | the company name, | | | |
| | location or the type | | | |
| | of service. | | | |
| Services | List of services | Y | Y | N |
| offered | offered by the PIN | | | |
| Duration | Time period specifying | Y | Y | Y |
| | how long the PIN can | | | |
| | be active | | | |
| Current | Current measured KPIs | Y | Y | Y |
| PIN KPIs | for this PIN (e.g., | | | |
| | average PIN | | | |
| | communication | | | |
| | request service | | | |
| | rate, average | | | |
| | PIN communication | | | |
| | response time, average | | | |
| | number of supported PIN | | | |
| | elements, average | | | |
| | range/distance (e.g., | | | |
| | feet) between PEGCs | | | |
| | and PIN elements it | | | |
| | services) | | | |
| PEMC list | The list of identifiers | Y | Y | Y |
| | of the PIN elements | | | |
| | which are currently | | | |
| | serving as PEMC | | | |
| | (e.g.: PIN client ID, | | | |
| | UE GPSI etc.,) | | | |
| > PEMC | Endpoint information of | Y | Y | Y |
| Endpoint | each PEMC (e.g. URI, | | | |
| | FQDN, IP address) used | | | |
| | to communicate with | | | |
| | the PEMC. | | | |
| > Duration | Time period of | Y | Y | Y |
| | being PEMC | | | |
| PEGC list | The list of identifiers | Y | Y | Y |
| | of the PIN elements | | | |
| | which are currently | | | |
| | serving as PEGC (e.g.: | | | |
| | PIN client ID, UE GPSI | | | |
| | etc.,) | | | |
| > PEGC | Endpoint information of | Y | Y | Y |
| Endpoint | each PEGC (e.g. URI, | | | |
| | FQDN, IP address) used | | | |
| | to communicate with the | | | |
| | PEGC. | | | |
| > Duration | Time period of | Y | Y | Y |
| | being PEGC | | | |
| > Supported | KPIs supported by this | Y | Y | Y |
| PEGC KPIS | PEGC (e.g., maximum | | | |
| | PIN communication | | | |
| | request rate, | | | |
| | minimum PIN | | | |
| | communication response | | | |
| | time, maximum | | | |
| | number of assigned | | | |
| | PIN elements, max | | | |
| | range/distance (e.g., | | | |
| | feet) between PEGC and | | | |
| | the PIN elements it | | | |
| | services) | | | |
| > Current | Current measured KPIs | Y | Y | Y |
| PEGC KPIs | for this PEGC (e.g., | | | |
| | average PEGC | | | |
| | communication request | | | |
| | service rate, average | | | |
| | PEGC communication | | | |
| | response time, average | | | |
| | number of supported PIN | | | |
| | elements, average | | | |
| | range/distance (e.g., | | | |
| | feet) between PEGC and | | | |
| | the PIN elements it | | | |
| | services) | | | |
| > PEGC | Scheduled times when | Y | Y | Y |
| Schedule | this PEGC is available | | | |
| | to service PIN elements | | | |
| | or PIN groups. Schedule | | | |
| | may also be defined | | | |
| | to differentiate | | | |
| | times in which PEGC | | | |
| | may function as a default | | | |
| | PEGC vs. a backup | | | |
| | PEGC. | | | |
| > PIN Elements | List of PIN elements | Y | Y | Y |
| details | or PIN groups being | | | |
| | served by this PEGC | | | |
| | and their connectivity | | | |
| | information | | | |
| >> PIN Element | Identity of this PIN | Y | Y | Y |
| or Group ID | element or PIN group | | | |
| | being serviced by | | | |
| | this PEGC | | | |
| >> PEGC Role | Whether this PEGC is | Y | Y | Y |
| | serving as default | | | |
| | (primary) or backup | | | |
| | (secondary) PEGC | | | |
| | for this PIN element | | | |
| | or PIN group | | | |
| >> Routing | List of authorization | Y | Y | Y |
| Authorization | policies defining the | | | |
| | list of other PIN | | | |
| | elements or PIN groups | | | |
| | that this PIN | | | |
| | element or PIN group | | | |
| | is permitted to | | | |
| | communicate with via | | | |
| | this PEGC | | | |
| PIN Server | The identifier of the | N | Y | Y |
| ID | PIN server that serves | | | |
| | the PIN | | | |
| PIN server | Endpoint information | N | Y | Y |
| Endpoint | (e.g. URI, FQDN, IP | | | |
| | address) used to | | | |
| | communicate with the | | | |
| | PIN server. | | | |
| PIN Elements | List of PIN elements | Y | Y | N |
| List | currently | | | |
| | registered/joined | | | |
| | the PIN | | | |
| > PIN | Identity of the PIN | Y | Y | Y |
| Element ID | element | | | |
| > Services | Services offered by | Y | Y | Y |
| offered | the PIN element | | | |
| > Reachability | Reachability information | Y | Y | Y |
| information | of the PIN element | | | |
| > PIN group | List of IDs of the PIN | Y | Y | Y |
| List | groups which this PIN | | | |
| | element is a member of | | | |
| > capabilities | PIN capabilities of this | Y | Y | Y |
| | PIN element (e.g., | | | |
| | PEGC, PEMC, both) | | | |
| > Device | Identifier of the device | Y | Y | Y |
| identifier | (e.g., IMSI, MSISDN, | | | |
| | MAC address) hosting | | | |
| | this PIN element | | | |
| > Battery level | Battery level of this | Y | Y | Y |
| | PIN element | | | |
| > PINE | Operational schedule | Y | Y | Y |
| Schedule | (e.g. time windows) of | | | |
| | this PIN element and | | | |
| | it application client(s) | | | |
| > Heartbeat | Periodic timer controlling | Y | Y | Y |
| timer | how frequent this PIN | | | |
| | element issues a | | | |
| | heartbeat request | | | |
| | to the PEMC | | | |
| | indicating it is still | | | |
| | connected to PIN | | | |
| > Current | Current location of this | Y | Y | Y |
| location | PIN element | | | |
| > Expected | The expected locations | Y | Y | Y |
| locations | this PIN element | | | |
| | may move to (e.g., | | | |
| | name of one or | | | |
| | more rooms in a | | | |
| | household) | | | |
| > Access type | Type of access supported | Y | Y | Y |
| | by this PIN element | | | |
| | (e.g., 3GPP, non-3GPP, | | | |
| | both). For non-3GPP, | | | |
| | wifi, Bluetooth, Zigbee, | | | |
| | etc. | | | |
| > Access code | For non-3GPP access, | N | Y | Y |
| | authentication code | | | |
| | exchanged between PIN | | | |
| | elements | | | |
| > Default PEGC | Identifier of the default | Y | Y | Y |
| | PEGC authorized to | | | |
| | service this PIN element. | | | |
| | The PIN element will | | | |
| | use this PEC as the | | | |
| | primary PEGC to relay | | | |
| | PIN communications. | | | |
| | Location and/or schedule | | | |
| | information for the | | | |
| | default PEGC may | | | |
| | also be comprised | | | |
| | such that the | | | |
| | default PEGC may be | | | |
| | selected by the PIN | | | |
| | element based on its | | | |
| | current location and | | | |
| | proximity to the default | | | |
| | PEGC and/or the | | | |
| | availability schedule | | | |
| | of the default PEGC. | | | |
| > Backup | Identifiers of backup | Y | Y | Y |
| PEGCs List | PEGCs authorized to | | | |
| | service this PIN element. | | | |
| | The list may be in | | | |
| | prioritized order (the | | | |
| | first PEGC listed will | | | |
| | serve as the first | | | |
| | backup PEGC). If the | | | |
| | default PEGC is not | | | |
| | available, the first | | | |
| | backup PIN element | | | |
| | may use this | | | |
| | prioritized list of | | | |
| | PEGCs to relay PIN | | | |
| | communications. | | | |
| | Location and/or | | | |
| | schedule information | | | |
| | for each of the backup | | | |
| | PEGCs may also be | | | |
| | comprised such that a | | | |
| | backup PEGC may be | | | |
| | selected by the PIN | | | |
| | element based on its | | | |
| | current location and | | | |
| | proximity to a backup | | | |
| | PEGC and/or the | | | |
| | availability schedule | | | |
| | of the PEGC. The list | | | |
| | may be in prioritized | | | |
| | order. | | | |
| > Application | List of application | Y | Y | Y |
| List | clients of this PIN | | | |
| | element | | | |
| >> Application | Identity of this | Y | Y | Y |
| Identity | application client | | | |
| >> Application | Operational schedules | Y | Y | Y |
| schedule | of this application | | | |
| | client (e.g. time | | | |
| | windows) | | | |
| >> Application | Minimum PIN | Y | Y | Y |
| KPIs | communication KPIs | | | |
| | required by this | | | |
| | application client to | | | |
| | operate effectively | | | |
| | within the PIN (e.g., | | | |
| | PIN bandwidth, PIN | | | |
| | request rate, PIN | | | |
| | response time) | | | |
| > Assume | A configuration | Y | Y | Y |
| PEGC role | indicating if | | | |
| | this PIN element | | | |
| | is permitted to | | | |
| | transition to role of | | | |
| | PEGC should the default | | | |
| | and/or backup PEGCs | | | |
| | become unresponsive to | | | |
| | this PIN element | | | |
| > Current PIN | The current role of | Y | Y | Y |
| role | this PIN element (e.g., | | | |
| | PEMC, PEGC, both | | | |
| | PEMC | | | |
| | and PEGC, PIN element) | | | |
| > Supported | Service schedule (e.g., | Y | Y | Y |
| PEGC schedule | time windows) this PIN | | | |
| | element is capable | | | |
| | of supporting when | | | |
| | serving as a PEGC. | | | |
| > Supported | KPIs this PIN element | Y | Y | Y |
| PEGC KPIs | is capable of supporting | | | |
| | when serving as a PEGC | | | |
| | (e.g., maximum PIN | | | |
| | communication request | | | |
| | service rate, minimum | | | |
| | PIN communication | | | |
| | response time, maximum | | | |
| | number of assigned PIN | | | |
| | elements, level of | | | |
| | availability (e.g., | | | |
| | percentage of time), | | | |
| | maximum range/distance | | | |
| | (e.g., feet) between | | | |
| | PEGC and the PIN | | | |
| | elements it services) | | | |
| PIN Groups List | | Y | Y | Y |
| > PIN group ID | Identifier of the | Y | Y | Y |
| | PIN group | | | |
| > Max # | Maximum number | Y | Y | Y |
| Members | of PIN elements | | | |
| | allowed in the | | | |
| | PIN group | | | |
| > Member | Identifiers of the PIN | Y | Y | Y |
| PINEs | elements that are | | | |
| | members of the | | | |
| | PIN group | | | |
| > Group | Endpoint information | Y | Y | Y |
| Endpoint | of the PIN group (e.g. | | | |
| | URI, multicast IP | | | |
| | address) | | | |
| | used to communicate | | | |
| | with the member | | | |
| | PIN elements | | | |
| | of the group. | | | |

TABLE 3
PIN Client Profile Enhancements

| Informational | |
|---|---|
| Element | Parameter Description |
| PIN ID | The identifier of the PIN where the PIN client is joined |
| UE identifier | PIN Element or UE identifier |
| PIN client ID | The unique identity of the PIN client within PIN |
| Name of the | Human-readable name of the device (i.e. door sensor, |
| device | watch, smart TV, etc )along with manufacturer details |
| Application | List of application clients |
| List | |
| > Application | Identity of the application client |
| Identity | |
| > Application | See definition in Table 2 |
| schedule | |
| > Application | See definition in Table 2 |
| KPIs | |
| capabilities | capabilities of the PIN client like supports |
| | relay capability for other PIN elements, PEGC |
| | capability, PEMC capability, both PEGC and PEMC |
| | capability |
| Visibility | Determines whether this PIN element is discoverable |
| | by other PIN elements within PIN, discoverable by |
| | other UEs outside the PIN etc., |
| access type | Access type supported for the communication |
| Layer-2 details | Layer-2 address of the PIN element |
| Required | Identifies the list of services the PINE wants to consume |
| services | |
| Supported | Identifies the list of services the PINE is |
| services | providing and allowed to be accessed |
| Mobility | Indicator of whether this device is fixed/stationary |
| | or mobile |
| Current | See definition in Table 2 |
| location | |
| Expected | See definition in Table 2 |
| locations | |
| Access type | Type of access supported by this device (e.g., |
| | 3GPP, non-3GPP, both) |
| Battery level | See definition in Table 2 |
| PIN group list | See definition in Table 2 |
| Heartbeat | See definition in Table 2 |
| timer | |
| Default PEGC | See definition in Table 2 |
| Backup | See definition in Table 2 |
| PEGCs list | |
| Assume PEGC | See definition in Table 2 |
| role | |
| Current PIN | See definition in Table 2 |
| role | |
| Supported | See definition in Table 2 |
| PEGC | |
| schedule | |
| Supported | See definition in Table 2 |
| PEGC KPIS | |

The information elements in Table 1 and 2 may be managed by the PIN entity associated with the profile (e.g. PIN server, PEMC, PEGC, and PINE) and the information elements in Table 3 may be managed by the PIN client associated with the profile. Information elements playing an important role with respect to PEGC operations are briefly described hereinafter to provide examples on their use. The descriptions are not intended to describe all possible uses of the informational elements, nor is it intended to be used to limit the scope of the use of the informational elements.

The various KPI informational elements may be configured to provide information for PEGCs to handle and process PIN communications according to the requirements of PIN elements. For example, the Application KPIs in Table 1 may be compared to the Supported PEGC KPIs in Table 2 by a PEMC to determine an appropriate PEGC to serve a PINE. Furthermore, a PEMC may incorporate Current PEGC KPIs from Table 2 in conjunction with the aforementioned KPIs to make determination on PEGC loading. Other similar combinations of KPIs informational elements may be envisioned to assist with PEGC management.

Two important informational elements that may be pertinent for PEGC management are the Default PEGC and Backup PEGCs List. Both may be configured to inform PINEs of the PEGC that will service PIN communications. The default PEGC will be the primary PEGC that will relay PIN communications from PINEs and, in the event the default PEGC is not available, the PINE may communicate with one or more backup PEGCs to relay the PIN communications. Note that the backup PEGCs may be organized as a prioritized list of backup PEGCs. If more than one PEGCs are listed in the Backup PEGCs List, then the PINE may communicate first with the higher prioritized PEGC. In the case that Assume PEGC role information element is configured for a PINE, the Backup PEGCs List information element may be a prioritized list of PINEs that may assume the role of a PEGC in the event a PEGC is unable to serve as the backup PEGC (e.g., due to being out of schedule or in power saving mode). For example, a Backup PEGCs List may have the following configuration: [PEGC-B, PINE-5, PINE-7]. In this example, the primary backup PEGC is PEGC-B and if PEGC-B is unable to serve as the PEGC when PEGC-A, which is the default PEGC, fails or is unresponsive, then PINE-5 may assume the role of a temporary PEGC. If PINE-5 is also unable to serve as the PEGC, then PINE-7 may assume the role of the temporary PEGC. Alternatively, the Default PEGC and Backup PEGC List information elements may be realized as a single information element. The first entry in this list may be the default PEGC. Subsequent entries in the list may be backup PEGCs. The order of the backup PEGCs in the list may determine the prioritized order of backup PEGCs.

Other informational elements that may assist with PEGC management are the PEGC Schedule, PINE Schedule, and Supported PEGC schedule. These schedule informational elements may be used to determine when a PEGC can serve as either a default or backup PEGC and a PEMC may utilize the informational elements to configure default and backup PEGCs. For example, a schedule may be configured that PEGC-A will serve as the default PEGC from 8 am-8 pm and PEGC-B may serve as the default PEGC from 8 pm-8 am. Similar configurations may be envisioned for the backup PEGCs as well.

Several other information elements that may assist with PEGC management are the following: PIN group List, PIN group ID, Group endpoint: These informational elements may be used to form groups of PINE elements that a PEGC serves. The groups may be “sub-networks” of the PIN; Access type, Access code: Some PIN elements may use non-3GPP accesses such as Wifi, Bluetooth, and Zigbee. The non-3GPP accesses may use certain security codes to establish communications between the PINEs; Current location, Expected locations: These location informational elements may assist the PEGC and/or PINE to determine which PEGC to utilize for relaying PIN communications, especially when the communications are transported over the 5G network. Context information such as PDU session information may be exchanged, provisioned, and/or authorized for the new PEGC to support service continuity for the PINE; Mobility: This information element may be used to assist the PEGC in determining whether a PINE is stationary and is in a fixed location or is mobile and able to move about (e.g., within a PIN or in and out of a PIN); and Heartbeat timer: This information element controls the frequency at which a PEGC/PINE must check-in with a PEMC and may be used by a PEMC to detect if a PEGC/PINE has left the PIN or has become unresponsive if/when the PEMC fails to receive heartbeats from the PEGC/PINE.

### PEMC Management of PEGCs

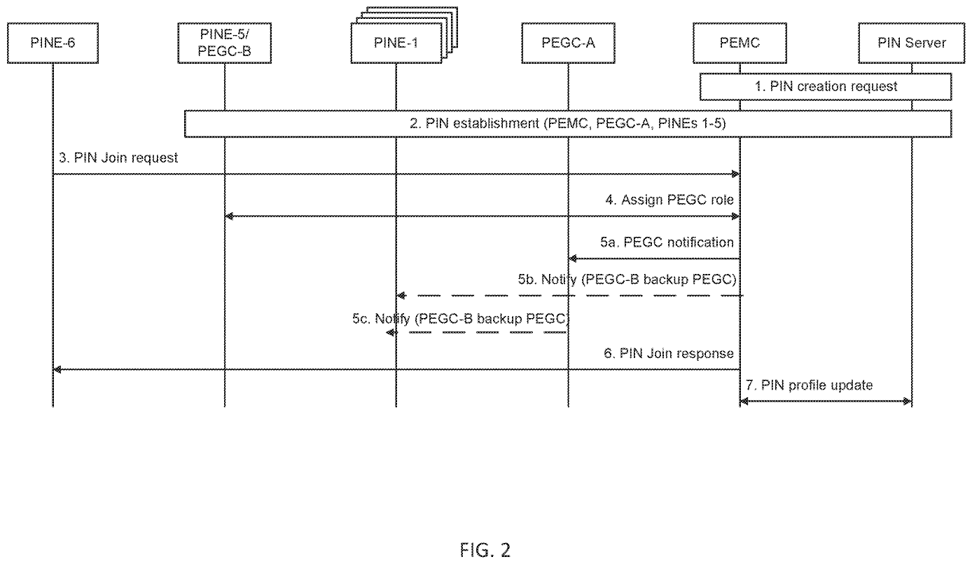

FIG. 2 shows an example method in which a PIN element may be assigned the role of a PEGC to provide load balancing for a PIN where there is a large number of PIN elements. In this example, a PEMC may have received authorization (from a PIN server) for creating a PIN and therefore has established a PIN with members PEMC, PEGC-A, PINEs 1-5. Thereafter, a new device (PINE-6) may request to join the PIN. When requesting to join the PIN, PINE-6 may provide the PEMC with PIN client profile information. Using this PIN client profile information coupled with dynamic PIN profile information that the PEMC also maintains, the PEMC may determine another PEGC is required to provide load balancing for PIN communications so as not to overload PEGC-A. The PEMC may then check whether any of the other PIN elements support PEGC capability. The PEMC may perform this check by examining the capabilities that the PIN elements may have shared with the PEMC when joining the PIN or that may have been updated thereafter. The PEMC identifies PINE-5 as having PEGC capability. Then the PEMC may assign PINE-5 with the role of the second active PEGC (PEGC-B) in the PIN. The PEMC may load balance the PIN elements across the two active PEGCs by configuring PEGC-A and PEGC-B with the list of PIN elements assigned to them. Then the PIN elements may be notified of the default and backup PEGCs they are assigned to.

In step 1 of FIG. 2, a PEMC may make a request to a PIN server to be authorized for PIN creation and the PIN server may grant the request and provision PIN profile information to the PEMC such as but no limited to the PIN information defined in Table 1 and Table 2.

In step 2, the PEMC may establish a PIN and assign the role of a default PEGC to a PIN element (e.g. PEGC-A). As additional PIN elements (PINEs 1-5) join the PIN, the PEMC may configure the PIN clients of these PIN elements to use PEGC-A as their default PEGC for PIN communications. The PEMC may also configure PEGC-A with PIN profile information indicating that PEGC-A is to serve as the default PEGC for PINEs 1-5. The PEMC may send a PIN profile update to the PIN server of the configuration of PEGC-A and PEGC-B as PEGCs.

In step 3, a new PIN element (PINE-6) may join the PIN. When joining the PIN, PINE-6 may send a PIN join request to the PEMC. This request may contain PIN client profile information such as but not limited to the information defined in Table 3. When receiving the request, the PEMC may determine that an additional PEGC is needed. This determination may be based on the PEMC comparing information contained in the PIN client profile of PINE-6 to the PIN profile information maintained and stored by the PEMC. For example, the PEMC may store PEGC KPIs supported by PEGC-A and using these KPIs, the PEMC may determine whether PEGC-A is able to support servicing PINE-6 in addition to servicing PINEs 1-5. The PEMC may make this determination by comparing information such as the minimum required KPIs of the application clients on PINEs 1-6 against the maximum KPIs supported by PEGC-A. For example, if the minimum KPIs of PINEs 1-6 exceed the maximum KPIs supported by PEGC-A, the PEMC may determine another PEGC is required within the PIN to load balance communication within the PIN across multiple PEGCs.

In step 4, after determining that an additional PEGC is required (i.e., only a single PEGC currently exists in the PIN) to load balance communication within the PIN, the PEMC may then determine if there is a candidate PIN element within the PIN that is capable of taking on the role of a PEGC. To make this determination, the PEMC may check PIN profile information that it stores and maintains such as but not limited to the information defined in Table 2. Within this PIN profile information, the supported capabilities of each of the PIN elements that have joined the PIN may be stored. This information may indicate whether a PIN element supports the capability to serve as a PEGC or not. If a PIN element is capable of serving as a PEGC, additional information may also be stored in the PIN profile such as the KPIs (e.g., Maximum PIN communication request service rate, Maximum PIN communication response time, Maximum number of assigned PIN elements, etc.) the PIN element is capable of supporting when serving as a PEGC. Based on this information, the PEMC may identify a PIN element (e.g., PINE-5) capable of serving the role of PEGC. The PEMC may then configure PINE-5 to serve as the default PEGC (PEGC-B) for PINE-6. In addition, the PEMC may also assign backup PEGC roles for added robustness and reliability. For example, the PEMC may assign PEGC-B to be the back-up PEGC for PINEs 1-4. The configuration of PINE-5 to serve as a default and/or backup PEGC may comprise the PEMC configuring PINE-5 with PIN profile information such as but not limited to the information captured in Table 2. For example, configuring PINE-5 with the current PIN role it is serving (PEGC), the list of PIN elements or PIN groups it is servicing as a PEGC, and whether it is servicing them in the role of a default or backup PEGC. The PEMC may also share similar information regarding other active PEGCs in the PIN. In turn, PINE-5 may choose to accept (or reject) the new role of PEGC and begin to operate as PEGC-B.

In step 5, the PEMC may notify PEGC-A (Step 5a) with an update of the dynamic PIN profile information indicating PEGC-B can serve as the backup PEGC for PINEs 1-4. The PEMC (step 5b) or PEGC-A (step 5c) may also inform PINEs 1-4 that PEGC-B can serve as their backup PEGC. Optionally, PEMC or PEGC-A may unicast, multicast or broadcast the updated information to PINEs 1-4 to inform them of the backup PEGC-B. Alternatively, to minimize control signaling, PEMC or PEGC-A may wait until future communications occur with PINEs 1-4 to provide the updated information of the backup PEGC-B to them.

In step 6, the PEMC may respond to PINE-6's request. Within the response, the PEMC may comprise updated PIN client profile information such as but not limited to the information captured in Table 3. For example, this information may comprise a default PEGC-B and the backup PEGC-A assigned to PINE-6.

In step 7, the PEMC may perform a PIN profile update to the PIN server to provide it with updated PEGC configuration information for the PIN. Note that this step may be made at any time after the PEMC makes the determination to configure a new role for PINE-5, e.g. after step 3. The PIN profile update may comprise the role change for PINE-5 and the new configurations for default and backup PEGCs.

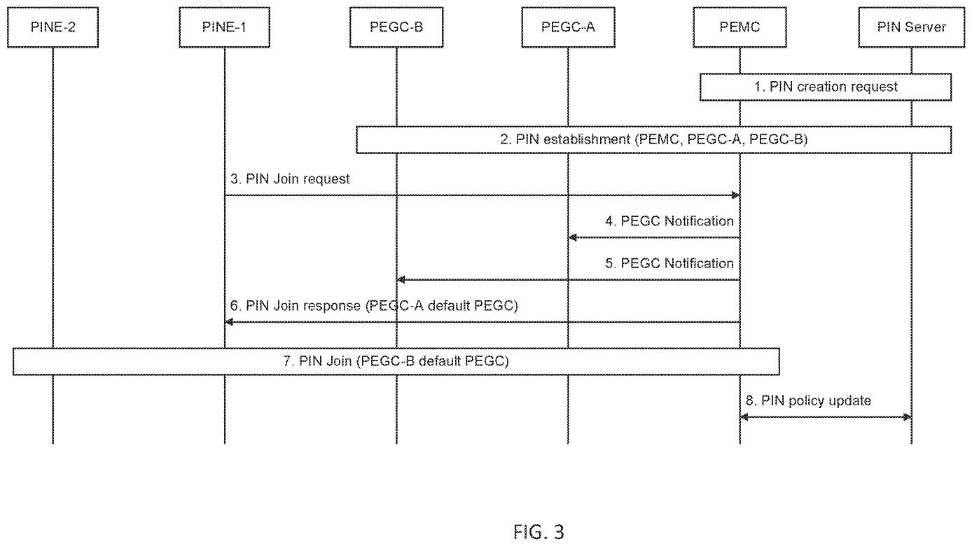

In the previous example, the decision to assign a PIN element with the role of a PEGC was made reactively in response to a new PIN element joining the PIN. FIG. 3 shows an example procedure of a more proactive approach in which a PEMC establishes a PIN by first assigning two PIN members with the role of a PEGC. During subsequent PIN element join requests, the PEMC may assign the PIN elements with default and backup PEGCs to balance the loading of each PEGC. This also provides enhanced robustness and reliability to the PIN in the event that problems are encountered with one of the PEGCs. For example, a PIN element may utilize the backup PEGC if it detects the default PEGC is not responding to its PIN communication requests or the default PEGC is not meeting the KPIs of the application clients of the PIN element.

For example, a PEMC may receive a PIN join request from a first PIN element comprising PIN client profile information of the first PIN element. The PIN client profile information of the first PIN element may indicate that the first PIN element is capable of serving as a gateway, or PEGC, in the PIN. The PEMC may also receive a second PIN join request from a second PIN element comprising PIN client profile information of the second PIN element. The PIN client profile information of the second PIN element may also indicate that the second PIN element is capable of serving as a gateway, or PEGC, in the PIN. The PEMC may determine that the first and/or the second PIN elements are capable of serving as a gateway, or PEGC, of the PIN based on the PIN client profile information of the respective PIN elements. The PEMC may configure the first and/or the second PIN elements as gateways, of PEGCs, of the PIN based on the PIN client profile information of the respective PIN elements. The PEMC may receiving a third PIN join request from a third PIN element comprising third PIN client profile information. The PEMC may determine that the third PIN element is in need of one or more gateways, or PEGCs. The PEMC may assign the first PIN element as a default gateway for the third PIN element and the second PIN element as a backup gateway for the third PIN element based on the PIN client profile information of first, second, and third PIN elements. The PEMC may send a notification to the first PIN element comprising information that indicates that the first PIN element is serving as the default gateway for the third PIN element. The PEMC may send a notification to the second OIN element comprising information indicating that the second PIN element is serving as the backup gateway for the third PIN element. The PEMC may send a response the third PIN element. The response may indicate that the first PIN element is serving as the default gateway and the second PIN element is serving as the backup gateway for communicating messages between the third PIN element and other elements in the PIN. The PEMC may detect the expiration of a heartbeat timer for the first PIN element. The expiration of the heartbeat timer may indicate that the first PIN element is no longer capable of serving as a gateway, or PEGC, for the third PIN element. Based on the expiration of the heartbeat timer, the PEMC may configure the second PIN element as the default gateway for third PIN element.

The PIN client profile information of the first and second PIN elements may comprise supported gateway, or PEGC, KPIs, and the third PIN client profile information may comprise application KPIs. Configuring the first PIN element to serve as the default gateway for the third PIN element and the second PIN element to serve as the backup gateway for the third PIN element may be based on the supported gateway, or PEGC, KPIs of the first and second PIN elements and the application KPIs of the third PIN element.

The PIN client profile information of the first and second PIN elements may comprise supported gateway, PEGC schedules, and the third PIN client profile information may comprise an application schedule. Configuring the first PIN element to serve as the default gateway for the third PIN element and the second PIN element to serve as the backup gateway for the third PIN element may be based on the supported gateway, or PEGC, schedules of the first and second PIN elements and the application schedule of the third PIN element.

The PIN client profile information of the first, second, and third PIN elements may comprise location information of the first, second, and third PIN elements, respectively. Configuring the first PIN element to serve as the default gateway for the third PIN element and the second PIN element to serve as the backup gateway for the third PIN element may be based on proximity of the third PIN element to the first and second PIN elements.

In step 1 of FIG. 3, a PEMC may make a request to a PIN server to be authorized for PIN creation and the PIN server may grant the request and provision PIN profile information to PEMC such as but no limited to the PIN information defined in Table 1 and Table 2.

In step 2, the PEMC may establish a PIN and determine to configure PEGC-A and PEGC-B as PIN elements with gateway functionality. The PEMC may make this determination by using targeted PIN KPIs (e.g., minimum PIN communication request service rate, maximum PIN communication response time, minimum number of supported PIN elements, etc.) defined in the PIN profile information the PEMC receives from the PIN Server. Alternatively, the PEMC may be configured with a policy or receive a request from an authorized administrator to have multiple PEGCs to support communications for the PIN. For example, the authorized administrator may know or have plans for a large number of PIN elements to be added to the PIN or may wish to have a certain level of availability, reliability, and robustness of communications within the PIN. The PEMC may send a PIN profile update to the PIN server of the configuration of PEGC-A and PEGC-B as PEGCs.

In step 3, the PINE-1 may send a PIN join request to the PEMC. Within this request, PINE-1 may comprise PIN client profile information such as but not limited to the information captured in Table 3. The PEMC receives the request and may configure PINE-1 to have PEGC-A as the default PEGC and PEGC-B as the backup PEGC. The PEMC may choose PEGC-A over PEGC-B as the default PEGC based on information that PINE-1 provides within its PIN client profile coupled with PIN information that the PEMC stores and maintains for PEGC-A and PEGC-B. For example, the PEMC may store the supported KPIs of each PEGC. The PEMC may also store information (e.g., identifiers, required KPIs, access type) for each PIN element currently assigned to PEGC-A and PEGC-B and whether PEGC-A and PEGC-B is serving as the default or backup PEGC for each of them. Based on this information, the PEMC may determine whether PEGC-A or PEGC-B is the better candidate to serve as the default PEGC.

In step 4, the PEMC may notify PEGC-A that it will serve as the default PEGC for PINE-1. When notifying PEGC-A, the PEMC may share dynamic PIN profile information such as but not limited to the information captured in Table 2.

In step 5, the PEMC may notify PEGC-B that it will serve PINE-1 as the backup PEGC. When notifying PEGC-B, PEMC may share dynamic PIN profile information such as but not limited to the information captured in Table 2.

In step 6, the PEMC may configure PINE-1 to have PEGC-A as the default PEGC and PEGC-B as the backup PEGC. When configuring PINE-1, the PEMC may share PIN client profile information such as but not limited to the information captured in Table 3.

In step 7, the PINE-2 may send a PIN join request to PEMC and steps 3-6 are repeated for PINE-2. PEMC may configure PINE-2 to have PEGC-B as the default PEGC and PEGC-A as the backup PEGC. PEMC may also notify PEGC-A and PEGC-B of the PEGC configurations.

In step 8, the PEMC may perform a PIN profile update with the PIN server and provide the updated PEGC configuration. The update may comprise information such as but not limited to the information defined in Table 2. Note that this step may be made at any time after step 3.

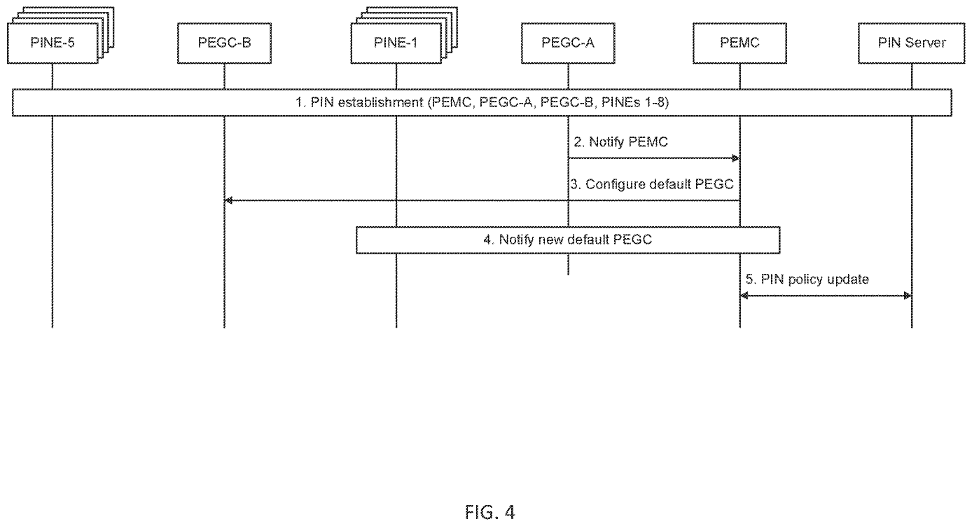

The configuration of default and backup PEGCs may assist the PEMC with handling emergency scenarios with a failing PEGC. For example, a PEGC (PEGC-A) may be running low on battery power and may notify the PEMC it is not able to continue serving as a PEGC. In another example, a PEGC may become overloaded with communication requests from the PIN elements it is servicing and notify the PEMC that it is overloaded. For these types of scenarios, the PEMC may quickly react to the notification and configure an available backup PEGC (PEGC-B) to serve as a new default PEGC as shown in FIG. 4 Error! Reference source not found. This quick action may preserve continuity of PIN communications and allow the PEMC time to select a new candidate PEGC.

In step 1 of FIG. 4, the PEMC may have been authorized to create a PIN and has established the PIN with PIN members: PEMC, PEGC-A, PEGC-B, and PINEs 1-8. PEGC-A may serve as the default PEGC for PINEs 1-4 and PEGC-B may serve as the default PEGC for PINEs 5-8. PEGC-A may be configured as the backup PEGC for PINEs 5-8 and PEGC-B may be configured as the backup PEGC for PINEs 1-4. The PEMC may send a PIN profile update to the PIN server of the configuration of PEGC-A and PEGC-B as PEGCs.

In step 2, the PEGC-A may be running low on battery power or may be overloaded such that it can no longer meet the required KPIs of the PIN elements it services. PEGC-A in turn may notify the PEMC that it is not able to continue serving as a PEGC or requires some offloading of some PIN elements to continue serving as a PEGC. PEGC-A may comprise in the notification dynamic PIN profile information such as its current battery level, or current KPIs indicating its current workload (e.g., average PIN communication request rate, average response time, current number of PIN elements being serviced, etc.). Alternatively, the PEMC may detect PEGC-A is not operational when it fails to receive a periodic heartbeat from PEGC-A.

In step 3, the PEMC may notify PEGC-B that it is now serving as the default PEGC (rather than the backup PEGC) for PINEs 1-4 (or a subset thereof). Not shown in the figure but the PEMC may also notify other PINE(s) (other than PEGC-B) that they are to serve as default or backup PEGC(s) similar to steps 4 and 5 defined for FIG. 3.

In step 4, optionally, the PEMC may unicast, multicast or broadcast a notification to PINEs 1-4 (or a subset thereof) with the new PEGC configuration, e.g. that PEGC-B will serve as the new default PEGC. If the PEMC had selected other PINEs to serve as the new PEGC, the PEMC may comprise information of the new PEGC, and whether the PEGC will be serving as the default or backup PEGC. The notification sent by the PEMC may comprise information such as but not limited to the PIN client information defined in Table 3.

In step 5, the PEMC may perform a PIN profile update with the PIN server and provide the updated PEGC configuration information. The update may comprise information such as but not limited to the information defined in Table 2. Note that this step may be made at any time after step 3.

### Backup PEGC Operations

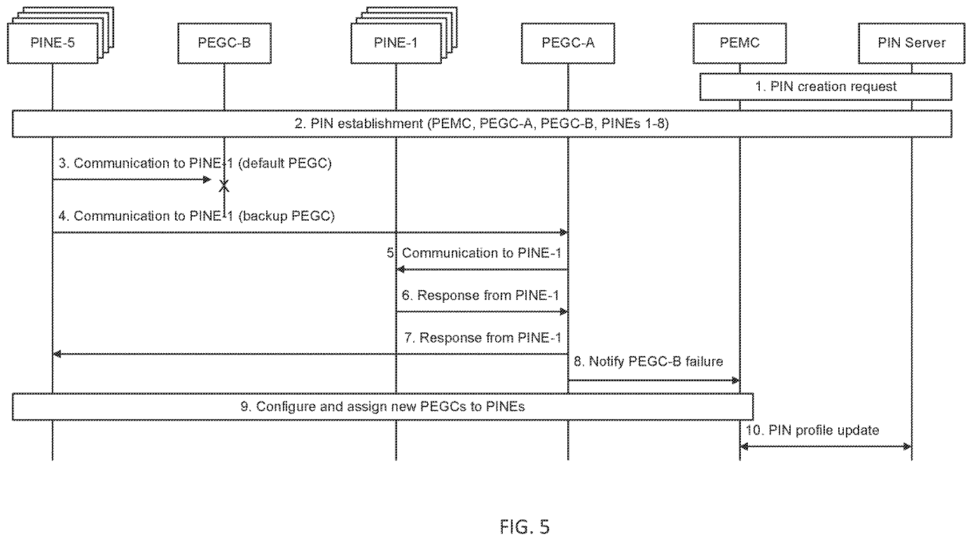

After a PEMC has configured multiple PEGCs for a PIN, PIN elements may use the configured information to dynamically react to interruptions to PIN communications. For example, if a PIN element is not able to send its communications to the default PEGC or the default PEGC is not able to meet the PIN element's required communication KPIs, the PIN element may instead send its communication to the backup PEGC. In addition, the PEMC may also be notified that the default PEGC is not responding and take necessary actions (e.g., find and assign another PIN element the role of PEGC). FIG. 5 Error! Reference source not found. shows such an example scenario.

In step 1 of FIG. 5, A PEMC may make a request to a PIN server to be authorized for PIN creation and the PIN server may grant the request and provision PIN profile information such as but not limited to the information defined in Table 1 to PEMC.

In step 2, the PEMC may establish the PIN with PIN members that comprise the PEMC, PEGC-A, PEGC-B, and PINEs 1-8. PEGC-A may serve as the default PEGC for PINEs 1-4 and PEGC-B may serve as the default PEGC for PINEs 5-8. PEGC-A may be configured as the backup PEGC for PINEs 5-8 and PEGC-B may be configured as the backup PEGC for PINEs 1-4. The PEMC may send a PIN profile update to the PIN server of the configuration of PEGC-A and PEGC-B as PEGCs.

In step 3, PINE-5 may send a communication to PINE-1 through PEGC-B, the default PEGC for PINE-5. The communication may be unsuccessful or fail to meet the required communication KPIs of PINE-5. As a result, PINE-5 may decide to try sending the communication to its backup PEGC, PEGC-A.

In step 4, PINE-5 may resend the communication to PINE-1 through PEGC-A, the backup PEGC for PINE-5. When sending this communication to PEGC-A, PINE-5 may also comprise information indicating the reason for using its backup PEGC rather than its default PEGC. This information may comprise an indication that the default PEGC is not reachable by PINE-5. Alternatively, the information may comprise an indication that PINE-5 is not receiving communication services from PEGC-B which meet the PIN elements required KPIs. Information regarding which KPIs are not being met as well as the amount of gap between required and actual observed KPIs may be provided as well.

In step 5, PEGC-A may check the dynamic PIN profile information it manages to ensure PINE-5 is authorized to use services of PEGC-A and is authorized to send communication to PINE-1. After successfully checking, PEGC-A may forward the communication to PINE-1.

In step 6, PINE-1 may return a response to PEGC-A to forward to PINE-5.

In step 7, PEGC-A may forward the response received from PINE-1 to PINE-5.

In step 8, PEGC-A may notify the PEMC that PINE-5 had utilized its backup PEGC rather than its default PEGC. When notifying the PEMC, PEGC-A may pass on the information it received from PINE-5 as described in Step 4 indicating the reason PINE-5 opted to use its backup PEGC-A rather than its default PEGC-B.

In step 9, the PEMC may try to communicate with PEGC-B to determine if PEGC-B is still unresponsive and/or assess the loading on PEGC-B. If the PEMC determines that PEGC-B is not operational or is overloaded, the PEMC may select and configure a new default PEGC for PINEs 5-8 (or a subset of PINEs 5-8) to replace PEGC-B as the default PEGCB (e.g. PEMC may perform steps 3-5 of FIG. 4).

In step 10, the PEMC may perform a PIN profile update with the PIN server and provide the updated PEGC configuration information. The update may comprise information such as but not limited to the information defined in Table 2.

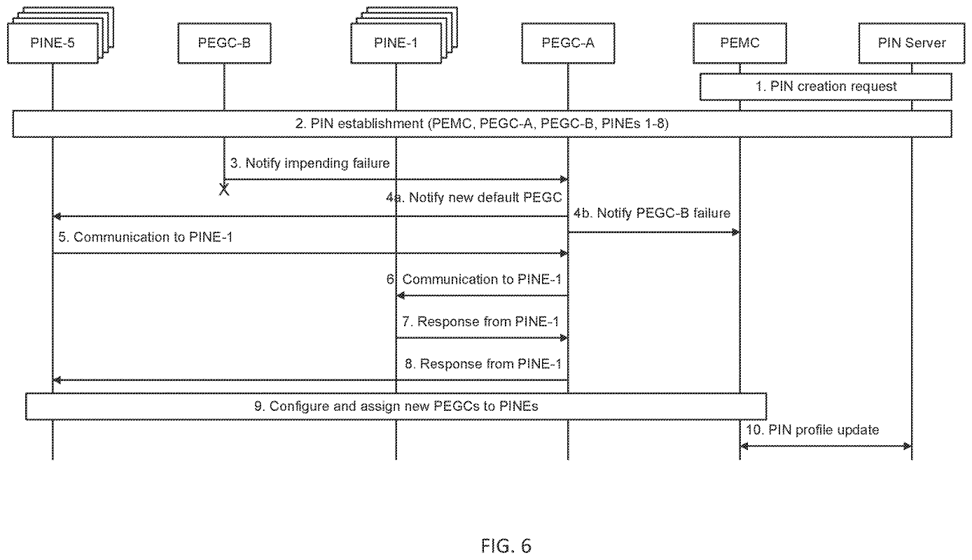

In certain cases, a PEGC may be aware when it will be unable to continue to serve as a gateway capable PIN element such as when the PEGC may be running low on battery power. During these scenarios, a PEGC may communicate with another PEGC serving the PIN to temporarily take over gateway capabilities on its behalf. FIG. 6 shows such an example where PEGC-B is running low on battery and communicates to PEGC-A to temporarily assume the role of gateway capability on behalf of PEGC-B. PEGC-A may then notify PEMC of the situation and temporarily serve as the new default PEGC for PINEs 5-8.

In steps 1-2 of FIG. 6, A PEMC may be authorized and may establish a PIN as described in steps 1-2 of FIG. 5.

In step 3, PEGC-B may be running low on battery power or may be failing due to another reason. PEGC-B may be configured to communicate to PEGC-A, which is the backup PEGC, to request for serving as the new default PEGC for the PIN elements that PEGC-B serves. PEGC-B may send PEGC-A PIN management information as shows in Table 2 and Table 3.

In step 4, upon accepting the new role, PEGC-A may notify PINEs 5-8 that PEGC-A will serve as the new default PEGC and may indicate a schedule for which PEGC-A will serve in this capacity. PEGC-A may also notify PINEs 1-4 that PEGC-B will no longer be serving as backup PEGC. PEGC-A may also notify PEMC that it is temporarily serving as default PEGC for PINEs 5-8 on behalf of PEGC-B and may indicate that it was informed that PEGC-B was failing and what the failure code was.

In steps 5-8, PINE-5 may have communication for PINE-1 and may send the communication to PEGC-A as described by steps 4-7 of FIG. 5.

In steps 9-10, the PEMC may try to communicate with PEGC-B to determine if PEGC-B is able to resume serving as a PEGC. If PEMC is unable to communicate to PEGC-B (e.g. due to PEGC-B being offline and unreachable), PEMC may configure a new PEGC for PINEs 5-8 and notify the PIN server of the new PIN configuration as described in steps 9-10 of FIG. 5.

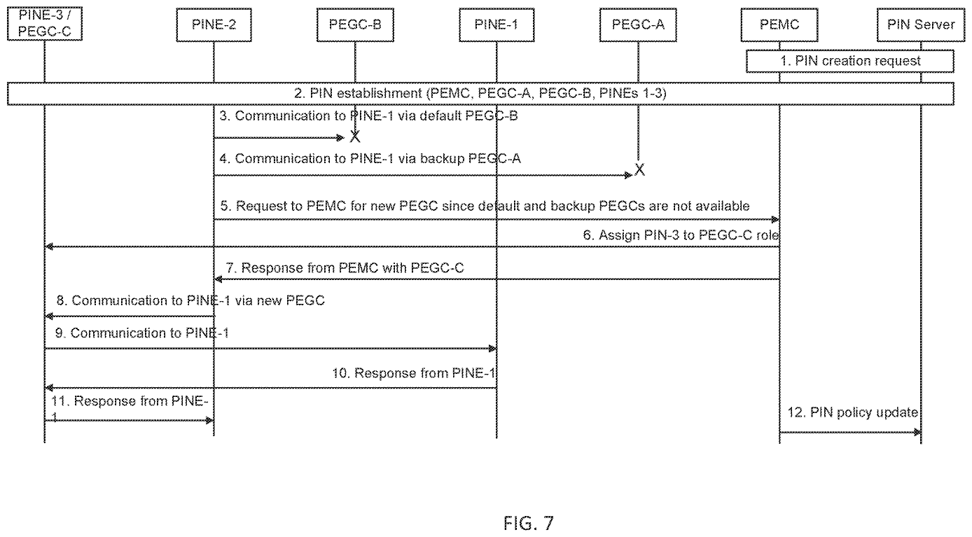

If a PIN element is not able to send its communication to either its assigned default PEGC or backup PEGC(s), the PIN element may notify the PEMC such that the PEMC can take action such as assigning a new PEGC for the PIN element to use. FIG. 7 shows such an example scenario.

In step 1 of FIG. 7, A PEMC may make a request to a PIN server to be authorized for PIN creation and the PIN server may grant the request and provision PIN profile information such as but not limited to the information defined in Table 1 to PEMC.

In step 2, the PEMC may establish the PIN with PIN members that comprise the PEMC, PEGC-A, PEGC-B, and PINEs 1-3. PEGC-A may serve as the default PEGC for PINE 1 and PEGC-B may serve as the default PEGC for PINEs 2 and 3. PEGC-A may be configured as the backup PEGC for PINEs 2 and 3 and PEGC-B may be configured as the backup PEGC for PINE 1. The PEMC may send a PIN profile update to the PIN server of the configuration of PEGC-A and PEGC-B as PEGCs.

In step 3, PINE-2 may send a communication to PINE-1 through PEGC-B, the default PEGC for PINE-1. The communication may be unsuccessful. As a result, PINE-2 may decide to try sending the communication to its backup PEGC, PEGC-A.

In step 4, PINE-2 may send a communication to PINE-1 through PEGC-A, the backup PEGC for PINE-2. The communication may be unsuccessful. As a result, PINE-2 may decide to notify the PEMC.

In step 5, PINE-2 sends a notification to the PEMC indicating that neither PEGC-A nor PEGC-B is reachable. [PINE-5 sends a request to PEMC to be assigned a different PEGC]. The PEMC may check if PEGC-A or PEGC-B are reachable. To perform this check, the PEMC may try and contact PEGC-A and PEGC-B. Alternatively, the PEMC may check if it has received the periodic heartbeat from PEGC-A or PEGC-B. If the PEMC determines that neither PEGC-A nor PEGC-B are reachable, the PEMC may determine if another PIN element in the PIN has the capability to serve as a PEGC. The PEMC may make this determination by checking the PIN client profile information that each PIN element shared with the PEMC when joining the PIN.

In step 6, after determining that PINE-3 has the capability to serve as a PEGC, the PEMC may configure PINE-3 to serve as a PEGC-C for the PIN. This configuration may be performed in a similar fashion as described in Step 4 of FIG. 2.

In step 7, the PEMC may respond to PINE-2's notification. Within the response, the PEMC may comprise updated PIN client profile information such as but not limited to the information captured in Table 3. For example, this information may comprise a default PEGC-C assigned to PINE-2. Although not shown in FIG. 7, the PEMC may also notify PINE-1 of the new default PEGC-C.

In step 8, PINE-2 may send a communication to PEGC-C targeting PINE-1

In step 9, PEGC-C may forward the request to PINE-1 from PINE-2

In step 10, PINE-1 may send response to PEGC-C

In step 11, PEGC-C may forward the response to PINE-2

In step 12, the PEMC may perform a PIN profile update with the PIN server and provide the updated PEGC configuration information. The update may comprise information such as but not limited to the information defined in Table 2. Note that this step may be made at any time after step 6.

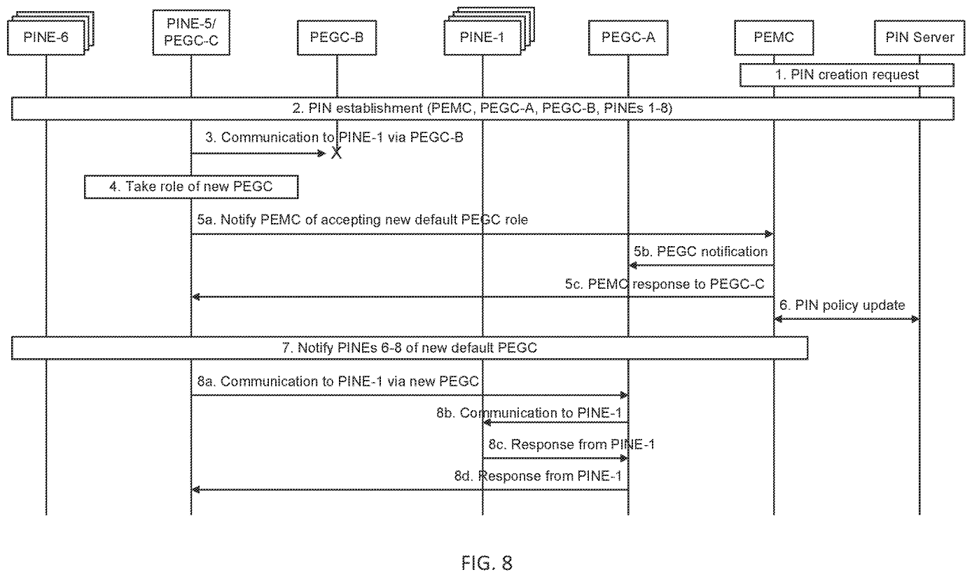

In the previous example, both the configured PEGCs for a PIN failed or were unavailable. As a result, PINE-2 had to make a request to the PEMC for assistance with configuring a new PEGC to support PIN communications. To address such an emergency scenario, a configuration parameter may be added to the PIN client profile where a PINE may be configured to automatically assume the role of a PEGC in this situation. During the PIN join procedure, a device may indicate whether it supports PIN gateway capability and the PEMC may use this information to configure certain PIN elements to automatically assume the role of a PEGC if/when the PIN element detects its default and backup PEGCs are unavailable. FIG. 8 shows an example scenario where a PINE assumes the role of a PEGC due to the unavailability of its default and backup PEGCs.

In step 1 of FIG. 8, a PEMC may make a request to a PIN server to be authorized for PIN creation and the PIN server may grant the request and provision PIN profile information such as but not limited to the information defined in Table 1 to PEMC.

In step 2, the PEMC may establish a PIN and determine to configure PEGC-A and PEGC-B as PIN elements with gateway functionality. PEGC-A will serve as the default PEGC for PINEs 1-4 with PEGC-B serving as the backup PEGC. Similarly, PEGC-B will serve as the default PEGC for PINEs 5-8 with PEGC-A serving as the backup PEGC. In addition, PINEs 2 and 5 have indicated they have gateway capability when they joined the PIN. In response, the PEMC may designate that PINEs 2 and 5 may serve as default PEGC for PEGC-A or PEGC-B, respectively, in the event that either PEGC-A or PEGC-B fails or is not able to continue to serve as the default PEGC. The PEMC may send a PIN profile update to the PIN server of the configuration of PEGC-A and PEGC-B as PEGCs.

In step 3, PINE-5 may need to communicate with PINE-1 and may send the communication to its default PEGC, PEGC-B. PEGC-B may have failed and does not respond to PINE-5's communication request.

In step 4, PINE-5 may detect that PEGC-B is not responding to the communication request and may decide to take the role of the default PEGC if it has gateway capability and is configured by PEMC to assume the role of a PEGC in the event that the default PEGC, e.g. PEGC-B, is unable to provide the gateway service.

In step 5, PINE-5 may notify the PEMC that it is taking the role of the new PEGC in place of PEGC-B. In response, the PEMC may notify PEGC-A that PINE-5 (PEGC-C) will serve as the new backup PEGC. The PEMC may also respond to PINE-5's notification, indicating the authorization for the role change of PINE-5 and may provide PINE-5 with dynamic PIN profile information such as new PIN identifier (e.g. PEGC-C) and the list of individual or groups of PIN elements that PINE-5/PEGC-C is to serve as the default PEGC and/or backup PEGC. The PEMC may also comprise routing authorization policies to PEGC-C defining the list of other PIN elements or PIN groups that each PIN element or PIN group is permitted to communicate with via PEGC-C. Not shown in FIG. 8, but PEGC-A may also inform PINEs 1-4 that PEGC-C may serve has backup PEGC.

In step 6, the PEMC may perform a PIN profile update with the PIN server and provide the updated PEGC configuration information. The update may comprise information such as but not limited to the information defined in Table 2. Note that this step may be made at any time after step 5.

In step 7, the PEMC may unicast, multicast or broadcast notification(s) to inform PINEs 6-8 that PEGC-C will serve as the new default PEGC. Not shown in FIG. 8, but the PEMC may also inform PINEs 1-4 that PEGC-C may serve has backup PEGC.

In step 8, PINE-5, now serving as the new PEGC-C, may forward the PIN communication targeting PIN-1 to PEGC-A which is serving as the default PEGC for PINE-1. PEGC-A may relay the PIN communication to PINE-1 and provide PINE-1's response to PINE-5/PEGC-C. Alternatively, PINE-5 may instead forward PIN communication directly to PIN-1 (not shown in FIG. 8) since PEGC-C serves as the backup PEGC for PINE-1.

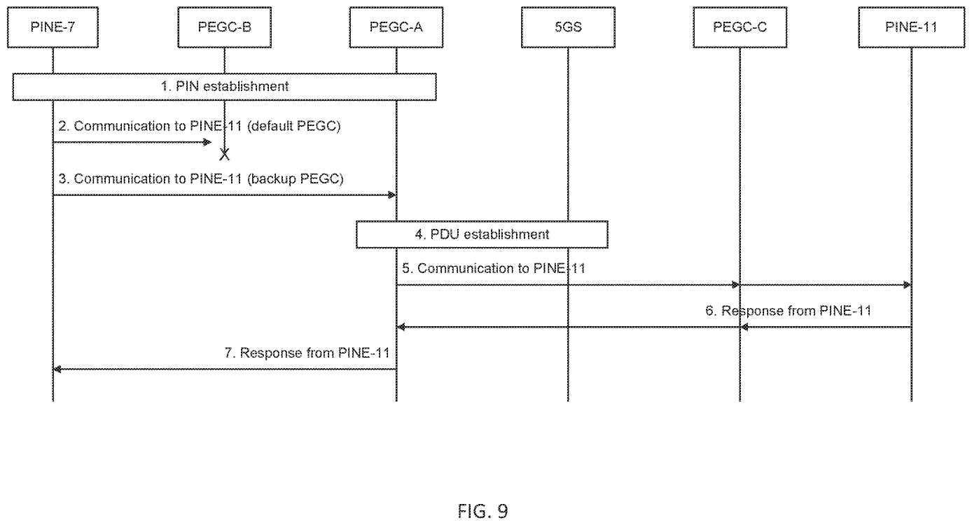

FIG. 9 shows an example process where PINE-7 may attempt to communicate with PINE-11 via communicating with its default PEGC-B which fails. As a result, PINE-7 may attempt to use its backup PEGC-A instead. When doing so, PEGC-A may establish a PDU session to enable PINE-7 to communicate with PINE-11 since this communication may span across the 5G network.

In step 1 of FIG. 9, a PIN may be established in which there are two PEGCs, PEGC-A and PEGC-B. The PIN may have 10 PIN members, PINEs 1-10.

In step 2, PINE-7 may have a need to communicate with PINE-11, which belongs to another PIN, and sends a communication to PEGC-B. The communication may comprise the PIN ID, PINE-11 ID, IP address and port number, and other application centric data. The communication may be unsuccessful, even after several attempts.

In step 3, PINE-7 may determine that PEGC-B has failed or is currently not available. Instead, PINE-7 may resend the communication to PEGC-A, the backup PEGC for PINE-7.

In step 4, PEGC-A may receive the communication and based on the PIN ID and/or IP address, PEGC-A may determine that the communication needs to be sent over the 5G network. PEGC-A may check the routing authorization rules provided by the PEMC to PEGC-A to check if authorization for the communication from PINE-7 to PINE-11 is permitted. If PEGC-A finds the communication is permitted, it may establish a PDU session with the 5G network to carry the communication from PINE-7 to PINE-11.

In step 5, PEGC-A may send the communication to PEGC-C which is a PEGC residing in the other PIN in which PINE-11 resides. PEGC-C in turn forwards the communication to PINE-11.

In step 6, PINE-11 may return a response to the communication from PINE-7 through PEGC-C.

In step 7, PEGC-A may receive the response from PEGC-C and may forward the response to PINE-7.

### Location Based PEGC Operations

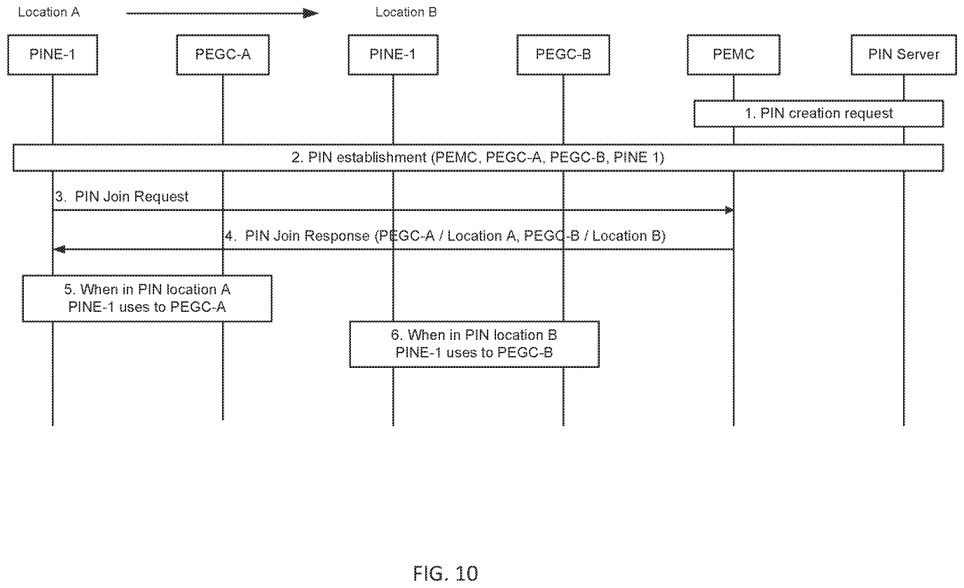

The PEMC may establish a PIN and determine to configure PEGCs in different locations throughout the PIN. In doing so, the PEMC may ensure the PIN has optimal PEGC coverage spanning across the entire coverage area of the PIN. For example, the PEMC may assign the role of PEGC to PIN elements located within different rooms or on different floors within a home or building. In addition, when PIN elements move about the PIN, the PEMC may adjust the default and/or backup PEGCs assigned to the PIN elements based on their new location. For example, the PEMC may change the default PEGC after a PIN element moves to a new location in the PIN (e.g., moves to a different room or to a different floor) such that the default PEGC is in closer proximity to the PIN element. The PEMC may also adjust which PIN elements are serving the role of PEGC based on the location of the PIN elements within the PIN. For example, the PEMC may assign/re-assign the role of PEGCs to PIN elements within a certain location within the PIN which has a high concentration of PIN elements to ensure the communication KPIs of the PIN elements can be met by the PEGCs. FIG. 10 shows such an example.

In step 1 of FIG. 10, a PEMC may make a request to a PIN server to be authorized for PIN creation and the PIN server may grant the request and provision PIN profile information such as but not limited to the information defined in Table 1 to PEMC.

In step 2, the PEMC may establish a PIN and determine to configure PEGCs in different locations throughout the PIN (e.g., within different rooms or on different floors throughout of house or building). The PEMC may determine which PIN elements to assign the role of PEGC by analyzing various types of information provided in the PIN client profiles of the PIN elements that have joined the PIN. For example, the PEMC may consider the current and expected locations of the PIN elements, which PIN elements are mobile, which PIN elements are stationary, the required application KPIs of each PIN element, which PIN elements have PEGC capabilities, and the supported PEGC KPIs of each PEGC capable PIN element. All or subset of this information may be analyzed by the PEMC when selecting the PIN elements to assign the role of PEGC. In doing so, the PEMC can ensure PEGCs are optimally distributed throughout the PIN in locations nearby their assigned PIN elements and that the PEGCs can meet the KPI requirements of their assigned PIN elements. For example, the PEMC may assign the role of PEGC to PEGC-A and PEGC-B which are located on different floors or within different rooms within a home.

In step 3, PINE-1 joins the PIN and may send a join request to PEMC. Within the request, PINE-1 may comprise a PIN client profile. Comprised within this profile may be information such as but not limited to the information defined in Table 3. For example, PINE-1 may provide its current location, its expected locations (if it's a mobile device), and the required KPIs of its application clients. Based on this information, the PEMC may select an optimal default PEGC to assign to the PIN element. For example, the PEGC located nearest to the PIN element and which may meet the KPI requirements of the PIN element may be selected. Likewise, the PEMC may also select one or more backup PEGCs to assign the PIN element to. When assigning backup PEGCs, the PEMC may factor in the expected location(s) of the PIN element and configure backup PEGC(s) having the closest proximity to these expected locations and that can also meet the KPI requirements of the PIN element.

In step 4, the PEMC may respond to PINE-1. Comprised in the join response, the PEMC may comprise assigned PEGCs. For example, the PEMC may assign a default PEGC-A based on the current location A of PINE-1 and a backup PEGC-B based on the expected location B of PINE-1. In addition to the identifier and contact information for the PEGCs, the PEMC may also comprise the location information as well. This location information may then be used by PINE-1 (e.g., compare PEGC location to PINE-1 location) when determining which PEGC to use.

In step 5, while PINE-1 is located in location A (e.g., room 1 or floor 1 in a home or building) it may use PEGC-A for communicating with other PIN elements. Although not shown in FIG. 10, when the location of PINE-1 changes, PINE-1 may update its current location information element stored within the PEMC. Based on this location information, the PEMC may change the default PEGC to PEGC-A and the backup PEGC to PEGC-B. The PEMC may update PEGC-A and PEGC-B with this updated dynamic PIN profile information.

In step 6, when PINE-1 moves to location B (e.g., room 2 or floor 2 in a home or building) it may switch over to using backup PEGC-B for communicating with other PIN elements.

### PEGC Schedule Based Operations.

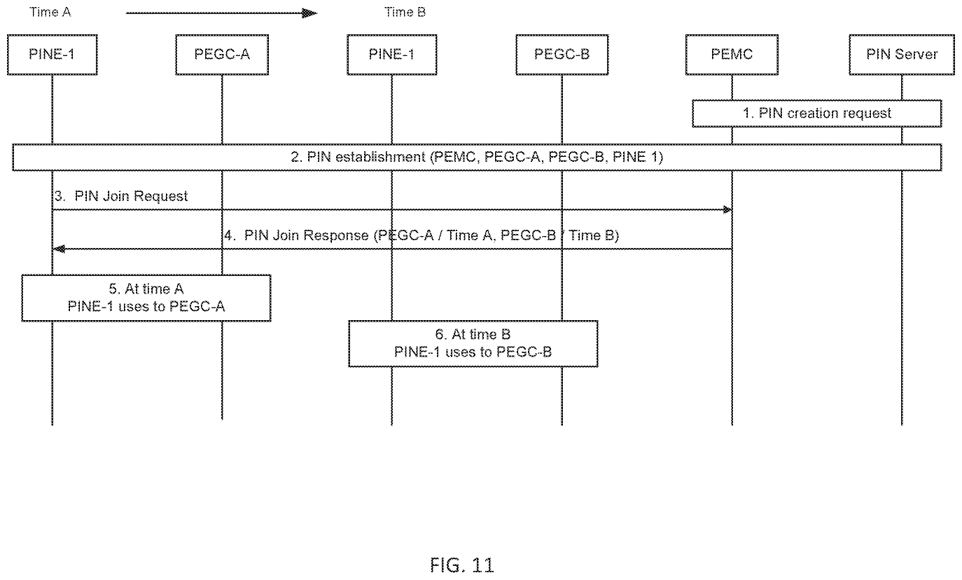

Certain PEGCs may only be available to service communication requests from PIN elements during certain scheduled time windows (e.g., between the hours of 8 pm and 8 am). For these types of use cases, it may be necessary for a PIN element to transition between using one or more backup PEGCs and the default PEGC based on the availability schedules of each of the PEGCs. Alternatively, a PIN element may be configured to use one PEGC (e.g. PEGC-A) during a certain schedule (e.g. 8 am to 8 pm) and another PEGC (e.g. PEGC-B) during a different schedule (e.g. 8 pm to 8 am). There may be different backup PEGCs for each schedule as well. FIG. 11 shows such an example.

In step 1 of FIG. 11, a PEMC may make a request to a PIN server to be authorized for PIN creation and the PIN server may grant the request and provision PIN profile information such as but not limited to the information defined in Table 1 to PEMC.

In step 2, the PEMC may establish a PIN and may determine to configure PEGCs with different availability schedules (e.g., time windows). The different schedules may be a result of the schedules supported by the PEGCs themselves, the schedule requirements of the PIN elements (and their application clients) assigned to the PEGCs, and/or the schedule requirements configured by a PIN administrator or a network operator. The PEMC may determine which PIN elements to assign the role of PEGC by analyzing various types of information provided in the PIN client profiles of the PIN elements that have joined the PIN. For example, the PEMC may consider the supported PEGC schedule of the PIN elements having PEGC capability and the application client schedule requirements of the various PIN elements within the PIN. In doing so, the PEMC can ensure collective schedules of the PEGCs are coordinated such that at least one default or backup PEGC is always available or at a minimum available during their scheduled communication time windows of the PIN elements.

In step 3, PINE-1 joins the PIN and may send a join request to PEMC. Within the request, PINE-1 may comprise a PIN client profile. Comprised within this profile may be information such as but not limited to the information defined in Table 3. For example, PINE-1 may provide one or more schedules for the one or more application clients of the PIN element. Based on this schedule information, the PEMC may select an optimal default PEGC to assign to the PIN element. For example, a PEGC having an availability schedule that overlaps completely with the schedules of the PIN element may be selected. If a single PEGC having a schedule that overlaps completely with the PIN element is not found, the PEMC may instead assign a default PEGC having the most schedule overlap and one or more backup PEGC that have overlap with any remaining time windows not covered by the default PEGC. Alternatively, the PEMC may adjust the schedules of one or more PEGCs such that they overlap completely with the schedule of the PIN element.

In step 4, the PEMC may respond to PINE-1. Comprised in the join response, the PEMC may comprise assigned PEGCs. For example, the PEMC may assign a default PEGC-A which covers a portion of the PINE-1 schedule and a backup PEGC-B that covers the remaining portion of the PINE-1 schedule. In addition to the identifier and contact information for the PEGCs, the PEMC may also comprise PEGC schedule information as well. This schedule information can then be used by PINE-1 (e.g., compare PEGC schedule to PINE-1 schedule) when determining which PEGC to use.

In step 5, while PINE-1 is communicating during a time period which overlaps with the schedule of default PEGC-A, it may use PEGC-A for communicating with other PIN elements.

In step 6, when PINE-1 is communicating during a time period which overlaps with the schedule of PEGC-B, it may switch to using backup PEGC-B for communicating with other PIN elements.

### Graphical User Interfaces

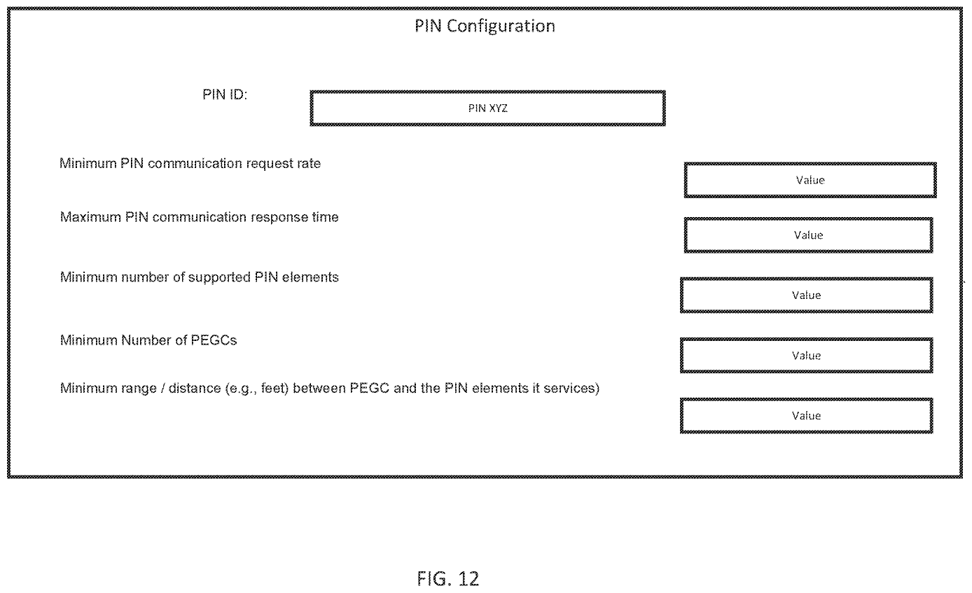

A PIN administrator may use a GUI to configure the PIN Server and/or PEMC with policies that may be used to determine how many PEGCs are needed within the PIN. Some examples are shown in FIG. 12.

A UI can support PIN client profile configuration on a PIN device (e.g., a UE). The UI may be used by a user or an administrator. The UI may support configuration of application client centric settings such as application client KPIs, schedule, expected locations, etc. The UI may also support PIN client centric configuration settings such as the supported PIN capabilities (e.g., PEMC, PEGC, both) the supported PEGC KPIs, etc.

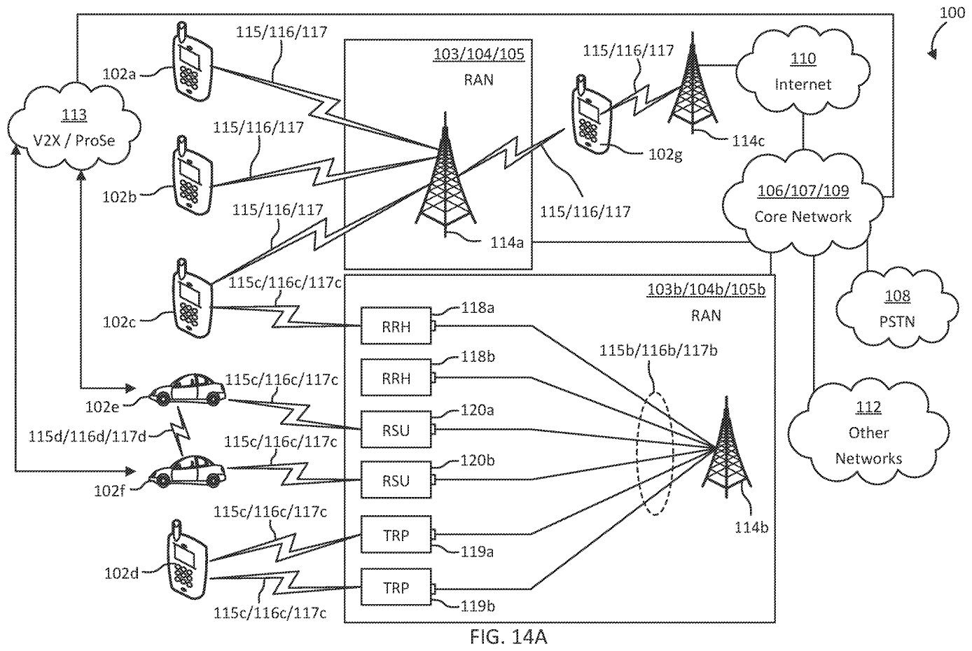

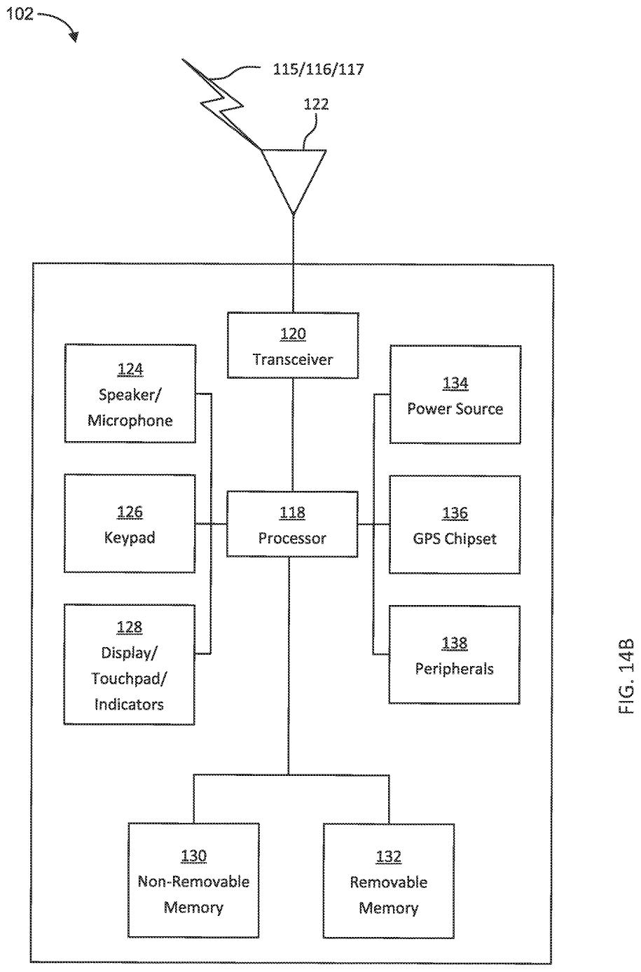

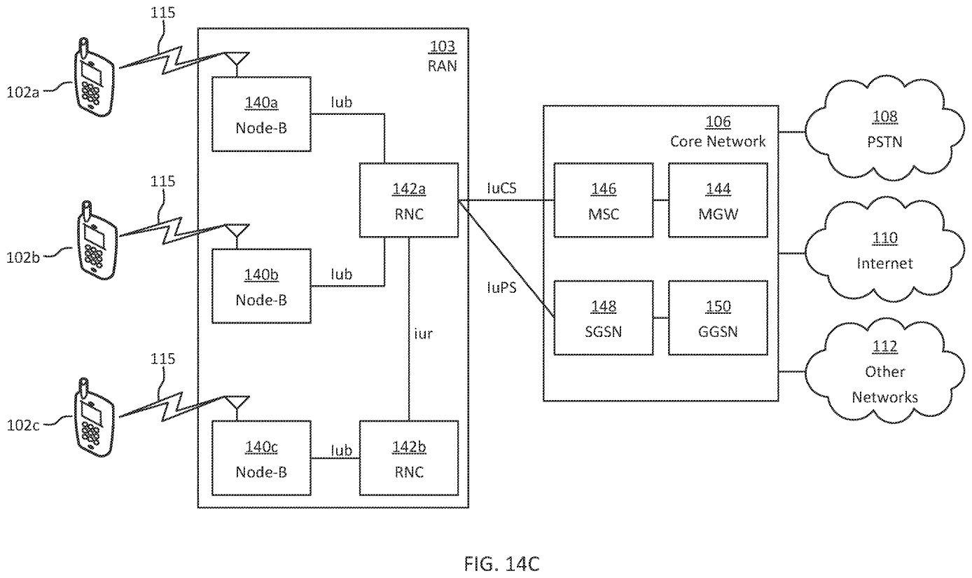

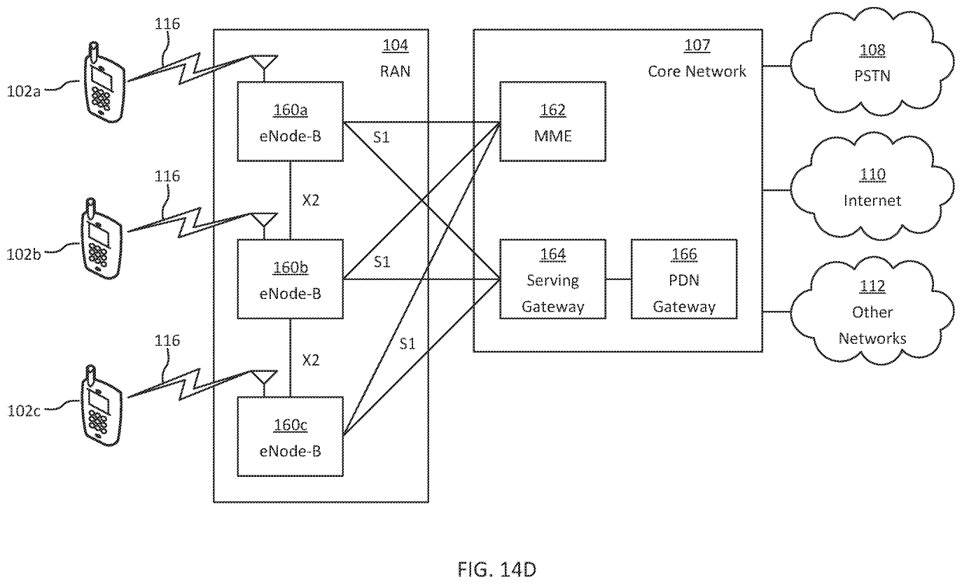

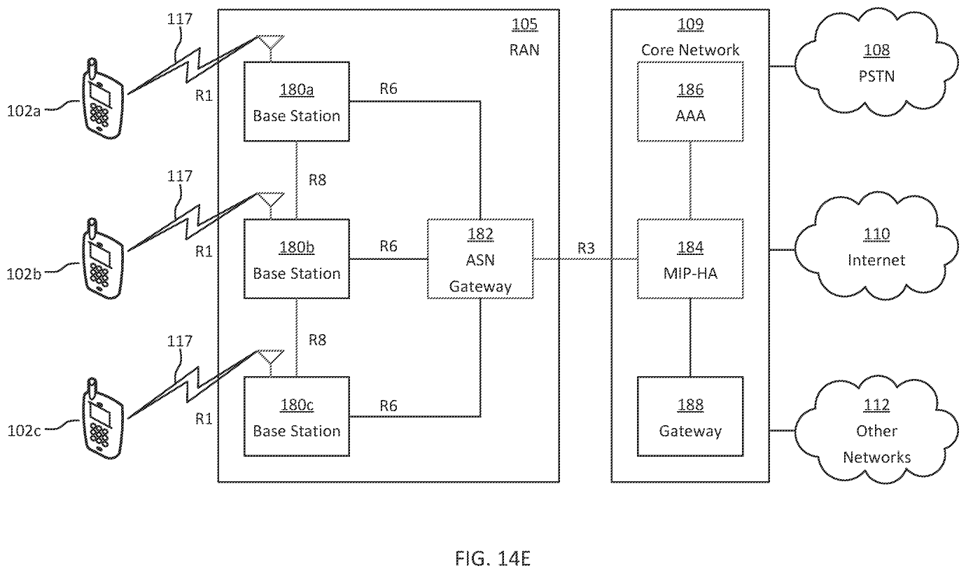

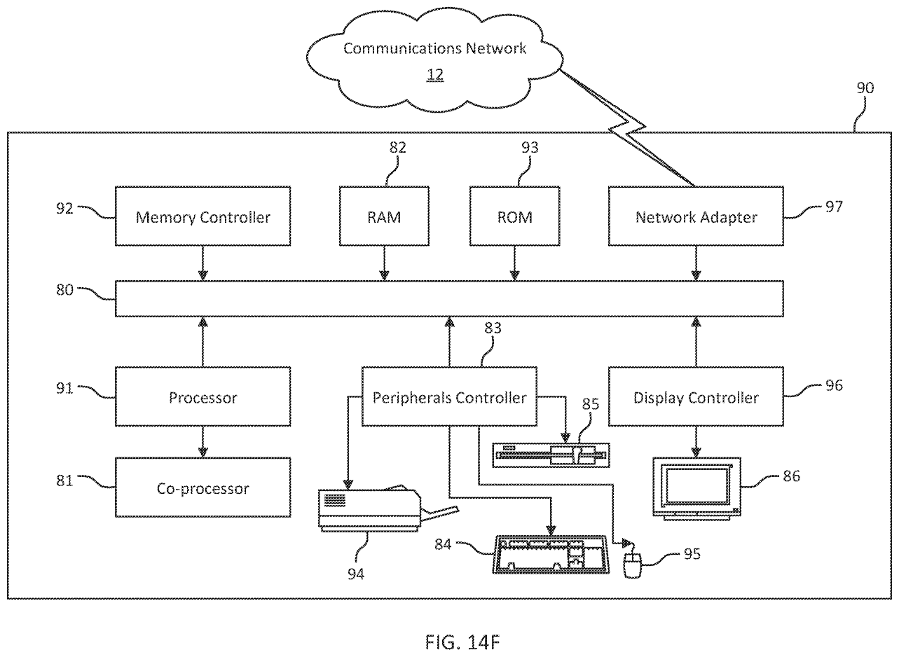

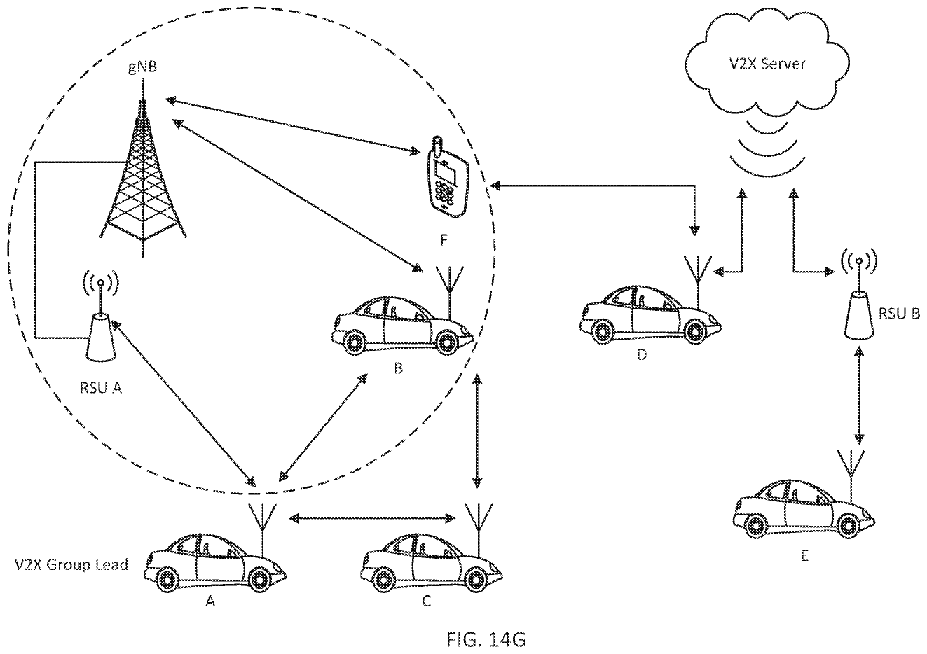

FIG. 14A illustrates one embodiment of an example communications system 100 in which the methods and apparatuses described and claimed herein may be embodied. As shown, the example communications system 100 may comprise wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed embodiments contemplate any number of WTRUs, base stations, networks, and/or network elements. Each of the WTRUs 102a, 102b, 102c, 102d, 102e, 102f, 102g may be any type of apparatus or device configured to operate and/or communicate in a wireless environment. Although each WTRU 102a, 102b, 102c, 102d, 102e, 102f, 102g is depicted in FIGS. 14A-14E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also comprise a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a, 114b may be a base transceiver station (BTS), a Node-B, an eNode B, a Home Node B, a Home e Node B, a site controller, an access point (AP), a wireless router, and the like. While the base stations 114a, 114b are each depicted as a single element, it will be appreciated that the base stations 114a, 114b may comprise any number of interconnected base stations and/or network elements.

The base station 114a may be part of the RAN 103/104/105, which may also comprise other base stations and/or network elements (not shown), such as a base station controller (BSC), a radio network controller (RNC), relay nodes, etc. The base station 114b may be part of the RAN 103b/104b/105b, which may also comprise other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, in an embodiment, the base station 114a may comprise three transceivers, e.g., one for each sector of the cell. In an embodiment, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may comprise communication protocols such as High-Speed Packet Access (HSPA) and/or Evolved HSPA (HSPA+). HSPA may comprise High-Speed Downlink Packet Access (HSDPA) and/or High-Speed Uplink Packet Access (HSUPA).

In an embodiment, the base station 114a and the WTRUs 102a, 102b, 102c, or RRHs 118a, 118b, TRPs 119a, 119b, and/or RSUs 120a, 120b, in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology. The LTE and LTE-A technology comprises LTE D2D and V2X technologies and interface (such as Sidelink communications, etc.) The 3GPP NR technology comprises NR V2X technologies and interface (such as Sidelink communications, etc.).

In an embodiment, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 14A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114c and the WTRUs 102e, may implement a radio technology such as IEEE 802.11 to establish a wireless local area network (WLAN). In an embodiment, the base station 114c and the WTRUs 102d, may implement a radio technology such as IEEE 802.15 to establish a wireless personal area network (WPAN). In yet another embodiment, the base station 114c and the WTRUs 102e, may utilize a cellular-based RAT (e.g., WCDMA, CDMA2000, GSM, LTE, LTE-A, etc.) to establish a picocell or femtocell. As shown in FIG. 14A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 14A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may comprise circuit-switched telephone networks that provide plain old telephone service (POTS). The Internet 110 may comprise a global system of interconnected computer networks and devices that use common communication protocols, such as the transmission control protocol (TCP), user datagram protocol (UDP) and the internet protocol (IP) in the TCP/IP internet protocol suite. The networks 112 may comprise wired or wireless communications networks owned and/or operated by other service providers. For example, the networks 112 may comprise another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may comprise multi-mode capabilities, e.g., the WTRUs 102a, 102b, 102c, 102d, and 102e may comprise multiple transceivers for communicating with different wireless networks over different wireless links. For example, the WTRU 102e shown in FIG. 14A may be configured to communicate with the base station 114a, which may employ a cellular-based radio technology, and with the base station 114c, which may employ an IEEE 802 radio technology.

FIG. 14B is a block diagram of an example apparatus or device configured for wireless communications in accordance with the embodiments illustrated herein, such as for example, a WTRU 102. As shown in FIG. 14B, the example WTRU 102 may comprise a processor 118, a transceiver 120, a transmit/receive element 122, a speaker/microphone 124, a keypad 113, a display/touchpad/indicators 128, non-removable memory 130, removable memory 132, a power source 134, a global positioning system (GPS) chipset 136, and other peripherals 138. It will be appreciated that the WTRU 102 may comprise any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may comprise some or all of the elements depicted in FIG. 14B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 14B shows the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 7B as a single element, the WTRU 102 may comprise any number of transmit/receive elements 122. More specifically, the WTRU 102 may employ MIMO technology. Thus, in an embodiment, the WTRU 102 may comprise two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may comprise multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may comprise random-access memory (RAM), read-only memory (ROM), a hard disk, or any other type of memory storage device. The removable memory 132 may comprise a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may comprise one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may comprise one or more software and/or hardware modules that provide additional features, functionality and/or wired or wireless connectivity. For example, the peripherals 138 may comprise various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 14C is a system diagram of the RAN 103 and the core network 106 according to an embodiment. As noted above, the RAN 103 may employ a UTRA radio technology to communicate with the WTRUs 102a, 102b, and 102c over the air interface 115. The RAN 103 may also be in communication with the core network 106. As shown in FIG. 7C, the RAN 103 may comprise Node-Bs 140a, 140b, 140c, which may each comprise one or more transceivers for communicating with the WTRUs 102a, 102b, 102c over the air interface 115. The Node-Bs 140a, 140b, 140c may each be associated with a particular cell (not shown) within the RAN 103. The RAN 103 may also comprise RNCs 142a, 142b. It will be appreciated that the RAN 103 may comprise any number of Node-Bs and RNCs while remaining consistent with an embodiment.

As shown in FIG. 14C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an lub interface. The RNCs 142a, 142b may be in communication with one another via an lur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 14C may comprise a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may comprise other wired or wireless networks that are owned and/or operated by other service providers.

FIG. 14D is a system diagram of the RAN 104 and the core network 107 according to an embodiment. As noted above, the RAN 104 may employ an E-UTRA radio technology to communicate with the WTRUs 102a, 102b, and 102c over the air interface 116. The RAN 104 may also be in communication with the core network 107.

The RAN 104 may comprise e Node-Bs 160a, 160b, 160c, though it will be appreciated that the RAN 104 may comprise any number of eNode-Bs while remaining consistent with an embodiment. The eNode-Bs 160a, 160b, 160c may each comprise one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 14D, the eNode-Bs 160a, 160b, 160c may communicate with one another over an X2 interface.

The core network 107 shown in FIG. 7D may comprise a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may comprise, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may comprise other wired or wireless networks that are owned and/or operated by other service providers.

FIG. 14E is a system diagram of the RAN 105 and the core network 109 according to an embodiment. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 14E, the RAN 105 may comprise base stations 180a, 180b, 180c, and an ASN gateway 182, though it will be appreciated that the RAN 105 may comprise any number of base stations and ASN gateways while remaining consistent with an embodiment. The base stations 180a, 180b, 180c may each be associated with a particular cell in the RAN 105 and may comprise one or more transceivers for communicating with the WTRUs 102a, 102b, 102c over the air interface 117. In an embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that comprises protocols for facilitating WTRU handovers and the transfer of data between base stations. The communication link between the base stations 180a, 180b, 180c and the ASN gateway 182 may be defined as an R6 reference point. The R6 reference point may comprise protocols for facilitating mobility management based on mobility events associated with each of the WTRUs 102a, 102b, 102c.

As shown in FIG. 14E, the RAN 105 may be connected to the core network 109. The communication link between the RAN 105 and the core network 109 may defined as an R3 reference point that comprises protocols for facilitating data transfer and mobility management capabilities, for example. The core network 109 may comprise a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may comprise other wired or wireless networks that are owned and/or operated by other service providers.

Although not shown in FIG. 14E, it will be appreciated that the RAN 105 may be connected to other ASNs and the core network 109 may be connected to other core networks. The communication link between the RAN 105 the other ASNs may be defined as an R4 reference point, which may comprise protocols for coordinating the mobility of the WTRUs 102a, 102b, 102c between the RAN 105 and the other ASNs. The communication link between the core network 109 and the other core networks may be defined as an R5 reference, which may comprise protocols for facilitating interworking between home core networks and visited core networks.

The core network entities described herein and illustrated in FIGS. 14A, 14C, 14D, and 14E are identified by the names given to those entities in certain existing 3GPP specifications, but it is understood that in the future those entities and functionalities may be identified by other names and certain entities, or functions may be combined in future specifications published by 3GPP, including future 3GPP NR specifications. Thus, the particular network entities and functionalities described and illustrated in FIGS. 14A, 14B, 14C, 14D, and 14E are provided by way of example only, and it is understood that the subject matter disclosed and claimed herein may be embodied or implemented in any similar communication system, whether presently defined or defined in the future.

FIG. 14F is a block diagram of an exemplary computing system 90 in which one or more apparatuses of the communications networks illustrated in FIGS. 14A, 14C, 14D and 14E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically comprises data lines for sending data, address lines for sending addresses, and control lines for sending interrupts and for operating the system bus. An example of such a system bus 80 is the PCI (Peripheral Component Interconnect) bus.

Memories coupled to system bus 80 comprise random access memory (RAM) 82 and read only memory (ROM) 93. Such memories comprise circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may comprise text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 comprises electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 14A, 14B, 14C, 14D, and 14E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 14G illustrates one embodiment of an example communications system 111 in which the methods and apparatuses described and claimed herein may be embodied. As shown, the example communications system 111 may comprise wireless transmit/receive units (WTRUs) A, B, C, D, E, F, a base station, a V2X server, and a RSUs A and B, though it will be appreciated that the disclosed embodiments contemplate any number of WTRUs, base stations, networks, and/or network elements. One or several or all WTRUs A, B, C, D, E can be out of range of the network (for example, in the figure out of the cell coverage boundary shown as the dash line). WTRUs A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media comprise volatile and nonvolatile, removable and non-removable media implemented in any non-transitory (e.g., tangible or physical) method or technology for storage of information, but such computer readable storage media do not comprise signals. Computer readable storage media comprise, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information, and which may be accessed by a computing system.

What is claimed:

1. A method comprising:
receiving, from a first element of a personal internet of things network (PIN) and by a PIN element with management capability (PEMC), a first PIN join request comprising first PIN client profile information indicating that the first PIN element is capable of serving as a gateway in the PIN;
receiving, from a second PIN element and by the PEMC, a second PIN join request comprising second PIN client profile information indicating the second PIN element is capable of serving as a gateway in the PIN;
determining, based on the first and second PIN client profile information, to configure the first and second PIN elements as gateways of the PIN;
receiving, from a third PIN element, a third PIN join request comprising third PIN client profile information;
determining, based on the first, second, and third PIN client profile information, to assign the first PIN element as a default gateway for the third PIN element and the second PIN element as a backup gateway for the third PIN element;
sending, to the first PIN element, a notification comprising information indicating that the first PIN element is serving as the default gateway for the third PIN element;
sending, to the second PIN element, a notification comprising information indicating that the second PIN element is serving as the backup gateway for the third PIN element; and
sending, to the third PIN element, a response indicating that the first PIN element is serving as the default gateway and the second PIN element is serving as the backup gateway for communicating messages between the third PIN element and other elements in the PIN.

2. The method of claim 1, wherein the first and second PIN client profile information comprises supported gateway key performance indicators (KPIs), and the third PIN client profile information comprises application KPIs.

3. The method of claim 2, wherein determining to configure the first PIN element to serve as the default gateway for the third PIN element and the second PIN element to serve as the backup gateway for the third PIN element is based on the supported gateway KPIs of the first and second PIN elements and the application KPIs of the third PIN element.

4. The method of claim 1, wherein the first and second PIN client profile information comprise supported gateway schedules and the third PIN client profile information comprises an application schedule.

5. The method of claim 4, wherein determining to configure the first PIN element to serve as the default gateway for the third PIN element and the second PIN element to serve as the backup gateway for the third PIN element is based on the supported gateway schedules of the first and second PIN elements and the application schedule of the third PIN element.

6. The method of claim 1, wherein the first, second, and third PIN client profile information comprises location information of the first, second and third PIN elements, respectively.

7. The method of claim 6, wherein determining to configure the first PIN element to serve as the default gateway for the third PIN element and the second PIN element to serve as the backup gateway for the third PIN element is based on the proximity of the third PIN element to the first and second PIN elements.

8. The method of claim 1, further comprising:
detecting the expiration of a heartbeat timer for the first PIN element; and
determining, based on the expiration of the heartbeat timer of the first PIN element, to configure the second PIN element to serve as the default gateway for the third PIN element.

9. An apparatus having management capability in a PIN, the apparatus comprising one or more processors configured to:
receive, from a first element of the PIN, a first PIN join request comprising first PIN client profile information indicating that the first PIN element is capable of serving as a gateway in the PIN;
receive, from a second element of the PIN, a second PIN join request comprising second PIN client profile information indicating the second PIN element is capable of serving as a gateway in the PIN;
determine, based on the first and second PIN client profile information, to configure the first and second PIN elements as gateways of the PIN;
receive, from a third PIN element, a third PIN join request comprising third PIN client profile information;
determine, based on the first, second, and third PIN client profile information, to assign the first PIN element to serve as a default gateway for the third PIN element and the second PIN element to serve as a backup gateway for the third PIN element;
send, to the first PIN element, a notification comprising information indicating that the first PIN element is serving as the default gateway for the third PIN element;
send, to the second PIN element, a notification comprising information indicating that the second PIN element is serving as the backup gateway for the third PIN element; and
send, to the third PIN element, a response indicating that the first PIN element is serving as the default gateway and the second PIN element is serving as the backup gateway for communicating messages between the third PIN element and other elements in the PIN.

10. The apparatus of claim 9, wherein the first and second PIN client profile information comprises supported gateway KPIs, and the third PIN client profile information comprises application KPIs.

11. The apparatus of claim 10, wherein the one or more processors is configured to determine to configure the first PIN element to serve as the default gateway of the third PIN element and the second PIN element to server as the backup gateway of the third PIN element based on the supported gateway KPIs of the first and second PIN elements and the application KPIs of the third PIN element.

12. The apparatus of claim 9, wherein the first and second PIN client profile information comprise supported gateway schedules and the third PIN client profile information comprises an application schedule.

13. The apparatus of claim 12, wherein the one or more processors is configured to determine to configure the first PIN element to serve as the default gateway for the third PIN element and the second PIN element to serve as the backup gateway for the third PIN element based on the supported gateway schedules of the first and second PIN elements and the application schedule of the third PIN element.

14. The apparatus of claim 9, wherein the first, second, and third PIN client profile information comprises location information of the first, second and third PIN elements, respectively.

15. The apparatus of claim 14, wherein the one or more processors is configured to determine to configure the first PIN element to serve as the default gateway for the third PIN element and the second PIN element to serve as the backup gateway for the third PIN element based on the proximity of the third PIN element to the first and second PIN elements.

16. The apparatus of claim 9, wherein the one or more processors is configured to:
detect the expiration of a heartbeat timer for the first PIN element; and
determine, based on the expiration of the heartbeat timer of the first PIN element, to configure the second PIN element to serve as the default gateway for the third PIN element.
